(19) United States
(12) Patent Application Publication
(10) Pub. No.: US 2025/0058367 A1
(43) Pub. Date: Feb. 20, 2025

(54) FULLY-AUTOMATED GENERATION OF FIXED-ANGLE ADDENDUMS FOR USE WITH SHEET FORMING MANUFACTURING

(71) Applicant: The Boeing Company, Arlington, VA (US)

(72) Inventor: Michael C. Elford, Brisbane (AU)

(73) Assignee: The Boeing Company, Arlington, VA (US)

(21) Appl. No.: 18/450,125

(22) Filed: Aug. 15, 2023

(51) Int. Cl. B21D 5/00; B21D 31/00

(52) U.S. Cl. CPC B21D 5/004; B21D 31/005

(57) ABSTRACT

A computer-implemented method of generating an addendum surface for use in forming a sheet metal part by using an Incremental Sheet Forming (ISF) manufacturing process, wherein the method includes: providing a Computer Aided Design (CAD) geometry of the sheet metal part to be formed; and generating an addendum surface that surrounds and extends the CAD geometry; wherein the addendum surface has a constant slope everywhere and has no regions of self-intersection. The addendum surface can be used to manufacture a male and/or a female underform tool for use in the ISF process, such as Two-Point Incremental Forming (TPIF). The addendum surface has a user-specified constant design wall angle, θ_{c}, which can be selected to prevent tearing of sheet metal parts during ISF due to excessive thinning at large wall angles (i.e., wall angles greater than 60°).

### INTRODUCTION

The present disclosure relates generally to manufacturing a sheet metal part using a sheet forming machine. More specifically, aspects of this disclosure relate to fully-automated, computerized generation of fixed-angle addendum surfaces for use in sheet forming and Incremental Sheet Forming (ISF) manufacturing processes.

Traditional metallic sheet forming processes include, but are not limited to, stamping, deep drawing, vacuum creep forming, hydroforming, explosive forming, and stretch forming. ISF is a more recently developed manufacturing process whereby a stylus tool travels along a predetermined toolpath in order to elastoplastically deform a sheet metal blank into the shape of a part.

In ISF, it is common for the stylus toolpath to take the form of a Z-level toolpath, whereby a reference surface geometry is offset by a given distance to form an offset surface, the distance being equal to the sum of the blank sheet thickness and the stylus radius in cases when the stylus end is hemispherical. This offset surface is then intersected with a plurality of constant Z-level planes to form a plurality of Z-level contours. These Z-level contours are connected with layer transitions, as well as travel to and from a stylus tool home position, in order to form a single, connected Z-level toolpath (e.g., see FIG. 23). The reference surface geometry is coincident with an inner mold line (IMIL) or outer mold line (OML) of a part to be formed.

FIG. 1A shows a schematic perspective view of an example of a Single Point Incremental Forming (SPIF) machine 94, where a sheet metal blank 10 is clamped around its perimeter with one or more clamps (shown herein as a single perimeter clamp 8). An ISF stylus tool 12 is then mounted into a collet (not shown) aligned with the Z-axis such that the stylus tool is perpendicular to the XY plane. An ISF machine controller (not shown) then executes a Computer Numerically Controlled (CNC) program to drive the stylus tool 12 along a predetermined stylus toolpath, which causes the tool to elastoplastically deform sheet metal blank 10 as it traverses over it. In SPIF, the stylus toolpath typically starts towards the perimeter of sheet metal blank 10 and then moves progressively inwards and downwards to form sheet metal part 16.

FIG. 1B shows a schematic example of a Two-Point Incremental Forming (TPIF) machine 92 with a male underform tool 7 positioned underneath sheet metal blank 10. The purpose of male underform tool 7 is to provide physical support to the backside of sheet metal blank 10 during forming and, as such, the surface geometry 170 of underform tool 7 where it contacts the sheet is coincident with the IML of the part being formed. In TPIF, when utilizing a male underform tool 7, the stylus 12 typically begins contacting the sheet metal blank 10 at the highest point or Z-contour of the underform male tool 7, then progressively moves downwards, forming the part in a series of contour loops with monotonically decreasing Z-level coordinate values, as defined by a stylus Z-level toolpath. Typically, edge clamp 8 is mounted on a frame assembly (not shown) that is movable in the Z-direction, as illustrated in FIG. 1B. In some instances, this downwards movement can be assisted by a downwards mechanical force, F; pulling the moveable frame assembly downwards to apply pressure from the underside of the sheet metal blank 10 onto the underform male tool 7 to improve overall formability.

FIG. 1C shows a different schematic example of the Two-Point Incremental Forming (TPIF) machine 92 with a female underform tool 13 positioned underneath sheet metal blank 10. The purpose of female underform tool 13 is to provide physical support to the underside of sheet metal blank 10 during forming and, as such, the surface geometry 170 of underform tool 13 where it contacts the sheet metal blank 10 is coincident with the OML of the part being formed. In TPIF, when utilizing a female underform tool 13, the stylus typically begins contacting the sheet blank along the highest point or Z-contour of underform female tool 13, then progressively moves downwards, forming the part in a series of contour loops with monotonically decreasing Z-level coordinate values, as defined by a stylus Z-level toolpath. Unlike using TPIF with a male underform tool 7, when using a female underform tool 13 the clamp 8 typically remains fixed in place.

In some examples, a TPIF machine 92 can utilize one or more underform male tools 7 and/or one or more female tools 13 made of polymer, wood, wood-polymer composite, aluminum, steel, or combinations thereof. All, or a portion of, the generated reference surface 14 can be used to define the shape of one or more underform tools 7 and 13, for use with sheet forming or ISF manufacturing processes.

FIG. 1D shows a schematic example of Dual-Sided Incremental Forming (DSIF) machine 96 with a pair of opposing stylus tools 12 and 15 that are positioned on opposite sides of sheet metal blank 10. The pair of stylus tools 12 and 15 move together in synchrony during sheet forming operations. The purpose of the opposing stylus tool 15 is to provide a movable physical support to the backside of sheet metal blank 10 during forming operations.

In ISF, the resulting sheet thickness after forming is often closely predicted by simply taking the cosine of the wall angle, θ, as measured with respect to the Z-axis, as indicated in FIG. 2A. For example, at a 45° wall angle, the remaining thickness is approximately equal to the cosine of 45° multiplied by the initial blank thickness, which equates to approximately 71% of the initial blank thickness. At a wall angle of 60°, this becomes cosine of 60° of the initial blank thickness, which makes the remaining thickness only 50% of the initial blank thickness. Usually, sheet forming angles greater than 60° are not achievable due to tearing of the sheet.

This wall thinning effect, commonly known as the “Sine Law”, is illustrated in FIG. 2A, which shows a schematic cross-sectioned perspective view of example of a hemispherical, male underform tool 7 with an underform tool surface geometry 170. A sheet metal blank 10 is being progressively formed downwards by stylus tool 12 using TPIF to follow the shape of hemispherical male tool 7 (having a reference surface 14). At the top of hemispherical male tool 7, the thickness, t, of sheet metal blank 10 is equal to the initial blank thickness, t_{blank}, (i.e., no thinning at the highest point on the tool). As the stylus tool 12 traverses outward and downward from the highest point, in progressively larger Z-level contours loops, sheet metal blank 10 stretches downward and thins out an amount which is closely predicted by the following formula:

$$t \approx {t}_{blank} cos ( θ )$$

wherein:
θ is the wall angle 160, as measured from the Z-axis;
t is the thickness of deformed sheet; and
t_{blank} is the thickness of the undeformed sheet metal blank 10.

FIG. 2B shows a schematic cross-sectioned example of a sheet metal blank 10 deformed by stylus tool 12 using TPIF and a constant wall angle 160, θ, according to the present disclosure. A truncated, cone-shaped, underform male tool 17 with a flat top 19 is shown. The wall angle 160, θ on the sloped portion of the sheet metal part 16 is a constant design wall angle θ_{c}=45°. In this example, the formed sheet metal part 16 has a constant (reduced) wall thickness along the conical wall region, which is approximately equal to cosine of 45° times the initial blank thickness, or approximately 71% of the initial blank thickness.

In many instances of manufacturing a sheet metal part 16 from a sheet metal blank 10, the part surface can be extended to form a region known as an “addendum”. An addendum is a portion of sheet metal blank 10 that will be formed into a sheet metal part 16, but will be discarded after the forming operation is completed. The addendum geometry is not included in the definition of the part itself, but is however required to facilitate sheet forming operations. For the purposes of this disclosure, the term ‘reference surface’ means a union of a part surface, a contiguous buffer zone surface (if present), and a contiguous addendum surface.

Generating an addendum surface from a Computer Aided Design (CAD) model of the part can be a tedious and time-consuming process. Depending on the complexity of the part geometry, it requires hours or even days of CAD work to generate the complex, three-dimensional shape of the addendum surface, which must then be joined contiguously with the part OML or IML geometry to form a reference surface from which a stylus toolpath can be constructed and, if required, underform tooling (tools) be manufactured.

In processes such as ISF, where thinning of a sheet metal part is highly dependent on wall angle, θ, it is advantageous to be able to generate an addendum with a constant design wall angle, θ_{c}, such that thinning in these regions can be controlled to prevent tearing. No automated method currently exists that generates an addendum surface that uses a constant (fixed) wall angle, θ_{c}, and that has no regions of self-intersection.

What is needed, then, is a fully-automated, computerizable method that rapidly and reliably generates the geometry of a constant-angle addendum surface from a given part surface geometry, regardless of complexity, while requiring only a few, user-selected input settings.

### SUMMARY

The present disclosure teaches a computer-implemented method of generating an addendum surface for use in forming a sheet metal part by using an Incremental Sheet Forming (ISF) manufacturing process, wherein the method includes: providing a Computer Aided Design (CAD) geometry of the sheet metal part to be formed; and generating an addendum surface that surrounds and extends the CAD geometry; wherein the addendum surface has a constant slope everywhere and has no regions of self-intersection. The addendum surface may be used to manufacture a male and/or a female underform tool for use in the ISF process, such as Two-Point Incremental Forming (TPIF). The addendum surface has a user-specified constant design wall angle, θ_{c}, which may be selected to prevent tearing of sheet metal parts during ISF due to excessive thinning at large wall angles (i.e., when θ_{c} is greater than 60°).

In an example, a computer-implemented method of generating an addendum surface for use in forming a sheet metal part by using an Incremental Sheet Forming (ISF) manufacturing process, includes providing a Computer Aided Design (CAD) geometry of the sheet metal part to be formed; and then generating an addendum surface that surrounds and extends the CAD geometry; wherein the addendum surface has a constant slope everywhere.

In an example, the addendum surface has no regions of self-intersection.

In an example, the computer-implemented method further includes extracting one or more part outer edge loops from the CAD geometry; and then generating one or more contiguous buffer zone surfaces around the one or more part outer edge loops; wherein the one or more contiguous buffer zone surfaces have one or more buffer zone edge slopes that match corresponding part outer edge slopes at every position along the one or more part outer edge loops.

In an example, the computer-implemented method further includes choosing a user-specified design wall angle, θ_{c}, that prevents tearing of the sheet metal part due to excessive wall thinning during the ISF manufacturing process.

In an example, the computer-implemented method further includes providing a user-specified design wall angle, θ_{c}; wherein the addendum surface has a wall angle, θ, that is constant everywhere on the addendum surface; and wherein the wall angle, θ, is equal to the user-specified design wall angle, θ_{c}.

In an example, the user-specified design wall angle, θ_{c}, is less than or equal to about 60°.

In an example, the computer-implemented method further includes providing a user-specified Z-trimming coordinate value; and then generating a trimmed flat base for the addendum surface by removing any portions of the addendum surface that lie below the user-specified Z-trimming coordinate value.

In an example, the computer-implemented method further includes manufacturing one or more underform tools by: computationally joining the sheet metal part surface, the one or more contiguous buffer zone surfaces, and the addendum surface with the trimmed flat base in a contiguous fashion to define a trimmed reference surface; then generating one or more underform tool CAD geometries that define one or more underform tools, each of which has a surface geometry that is coincident with at least part of the trimmed reference surface; and finally manufacturing one or more underform tools using the generated one or more underform tool CAD geometries.

In an example, the computer-implemented method further includes computationally joining the sheet metal part surface, the buffer zone surface, and the addendum surface in a contiguous fashion to make a reference surface; and then smoothing the reference surface to remove any surface discontinuities by performing one or more iterations of a Laplace, Laplace-Beltrami, or Taubin mesh smoothing algorithm.

In an example, a computer-implemented method of forming a sheet metal part using an Incremental Sheet Forming (ISF) manufacturing process includes: providing a Computer-Aided Design (CAD) geometry of a sheet metal part to be formed; then generating an addendum surface that surrounds and extends the CAD geometry, wherein the addendum surface has a fixed slope everywhere; then manufacturing one or more underform tools, each of which has an underform tool surface geometry that is coincident with at least part of the addendum surface and/or the sheet metal part surfaces; and finally incrementally sheet forming the sheet metal part over the one or more underform tools.

In an example, a computer-implemented method of generating an addendum surface for use in forming a sheet metal part using an Incremental Sheet Forming (ISF) manufacturing process includes: providing a Computer Aided Design (CAD) geometry of a sheet metal part to be formed; providing a user-specified design wall angle, θ_{c}; then calculating a set of x, y, and z-coordinate values for the addendum surface wherein the coordinates are defined such that all wall angles, θ of the addendum surface are equal to the user-specified design wall angle, θ_{c}; and finally generating the addendum surface using the set of x, y, and calculated z-coordinate values.

In an example, a computer-implemented method of forming a sheet metal repair patch using an Incremental Sheet Forming (ISF) manufacturing process includes: providing a Computer-Aided Design (CAD) geometry of a sheet metal repair patch to be formed; then providing a user-specified design wall angle, θ_{c}; then generating an addendum surface from the CAD geometry, wherein the addendum surface has a constant slope everywhere that is defined by the user-specified design wall angle, θ_{c}; and finally manufacturing an underform tool that includes the addendum surface; and incrementally sheet forming the sheet metal repair patch over the underform tool.

In an example, a computer-implemented method of generating a reference surface for use in a sheet forming manufacturing process includes:
(a) receiving from a user a geometrical representation of a part to be formed, wherein the part has a part surface;
(b) receiving a user-specified constant design wall angle, θ_{c};
(c) extracting one or more part outer edge loops from the part surface;
(d) receiving a user-specified buffer zone width;
(e) constructing one or more buffer zone surfaces by extending the one or more part outer edge loops by a distance equal to the user-specified buffer zone width in a direction that is constrained to lie within a local tangent space of the part surface at all points along the one or more part outer edge loops;
(f) extracting one or more buffer zone outer edge loops from the one or more buffer zone surfaces;
(g) generating one or more planar loops by projecting the one or more buffer zone outer edge loops onto an XY datum plane;
(h) computing a modified distance field, f
(i) generating a reference surface comprising a plurality of reference points with x, y and calculated z-coordinate values that satisfy a condition that f=0, and
(j) manufacturing the part from a sheet blank by using the generated reference surface with the sheet forming manufacturing process.

In an example, the computer-implemented method can include constructing the one or more buffer zone surfaces by extending the one or more part outer edge loops in a direction that is locally perpendicular to the one or more corresponding planar loops.

In an example, the computer-implemented method can further include:
(a) calculating the modified distance field, f on a voxel grid; and
(b) using a marching-cubes or marching-tetrahedrons algorithm to generate a level set surface of a level set;
wherein a value of the level set is set equal to zero; and
wherein if more than one calculated z-coordinate value exists with a given combination of x and y coordinates, then a reference point having a minimum z-coordinate value is used.

In an example, the computer-implemented method can further include setting the user-specified buffer zone width equal to zero.

In an example, the computer-implemented method can further include using a secant method to solve Eq. (1) for a z-coordinate value, given x and y coordinate values of a reference point, which satisfies the condition that f=0.

In an example, the computer-implemented method can further include if there is no valid real-valued solution to the modified distance value, f being zero for a given reference point with X and Y coordinates and given the user-specified constant design wall angle θ_{c}, then the method further includes using an optimization algorithm to seek a z-coordinate that minimizes f.

In an example, the computer-implemented method can further include smoothing the generated reference surface to remove one or more surface discontinuities by using a Laplace, Laplace-Beltrami, or Taubin mesh smoothing algorithm.

In an example, the computer-implemented method can further include using a weighting factor to control an amount of smoothing applied to the reference surface, wherein the weighting factor depends on a distance between the reference point and a closest point on the one or more buffer zone outer edge loops.

In an example, the computer-implemented method can further include;
(1) receiving a user-specified Z-trimming coordinate;
(2) constructing a trimming plane at the user-specified Z-trimming coordinate; and
(3) trimming the reference surface to remove all portions of the reference surface that lie below the trimming plane.

In an example, a computer-implemented method of manufacturing a part by using an ISF machine includes:
(1) providing an ISF machine that has a stylus tool;
(2) generating a reference surface of the part that has a part surface, wherein the reference surface includes a plurality of reference points;
(3) smoothing one or more discontinuities in the reference surface;
(4) trimming the reference surface with a trimming plane to remove all portions of the reference surface that lie below a user-specified Z-trimming coordinate;
(5) generating a stylus Z-level toolpath by using the smoothed and trimmed reference surface;
(6) exporting the stylus Z-level toolpath in a Computer Numerically Controlled (CNC) format that is compatible with a controller that controls operation of the ISF machine; and
(7) forming the part from a sheet blank by programming and operating the ISF machine to follow the generated stylus Z-level toolpath;
wherein the reference surface includes a union of a part surface, a contiguous buffer zone surface, and a contiguous addendum surface having a user-specified constant design wall angle, θ_{c}; and
wherein the plurality of reference points on the contiguous addendum surface include a subset of a level set surface of a modified distance field, f wherein f=0.

In an example, the computer-implemented method can include defining the modified distance field, f according to Eq. (1), as follows:

$$f = {( x - \hat{x} )}^{2} + {( y - \hat{y} )}^{2} - {tan}^{2} ( {θ}_{c} ) {( z - \hat{z} )}^{2} \qquad Eq . ( 1 )$$

wherein, given a reference point with x, y, and (calculated) z reference coordinates, then \hat{x}, ŷ and \hat{z} equal the x, y, and z-coordinates, respectively, of a closest point from the reference point along the one or more buffer zone outer edge loops.
wherein if the x and y coordinates of a reference point lie outside of the one or more planar loops, then a corresponding z-coordinate value equals a calculated z-coordinate value that satisfies the condition that f=0;
wherein if one or more calculated z-coordinates satisfy the condition that f=0, for a given reference point with x and y coordinates, then the corresponding z-coordinate equals a minimum z-coordinate value selected from the one or more calculated z-coordinates;
wherein if no z-coordinate satisfies the condition that f=0, for a given reference point with x and y coordinates, then the calculated z-coordinate equals a z-coordinate value that minimizes the modified distance field, f; and
wherein if the x and y coordinates are located inside of the planar loop, then calculate a point of intersection between a vertical line, having the same x and y coordinates as the reference point, and the part and buffer zone surface(s), wherein the calculated z-coordinate is equal to the z-coordinate value of the point of intersection.

In an example, the computer-implemented method can further include manufacturing one or more underform tools that include at least some portion of the reference surface; and forming the part from a sheet blank by programming and operating a Two-Point Incremental Sheet Forming (TPIF) machine that uses a stylus tool to follow the generated stylus Z-level toolpath; wherein the part being formed is physically supported by the one or more underform tools, which are located underneath the sheet blank.

In an example, the computer-implemented method can further include manufacturing the part from a sheet blank by programming and operating a Single Point Incremental Forming (SPIF) machine to elastoplastically deform the sheet blank, without using any physical support from an underform tool.

In an example, the computer-implemented method further includes manufacturing the part from a sheet blank by programming and operating a Dual Sided Incremental Forming (DSIF) machine with two opposing stylus tools that move together in a synchronous manner to elastoplastically deform the sheet blank that is positioned between the two opposing stylus tools, without using any physical support from an underform tool.

In an example, a non-transitory, computer-readable, digital storage medium includes computer instructions for executing a computer program that implements a computerized method of generating a reference surface for use in a sheet forming manufacturing, including computer instructions for:
(a) receiving from a user a geometrical representation of a part to be formed, wherein the part has a part surface;
(b) receiving a user-specified constant design wall angle, θ_{c};
(c) extracting one or more part outer edge loops from the part surface;
(d) receiving a user-specified buffer zone width;
(e) constructing one or more buffer zone surfaces by extending the one or more part outer edge loops by the user-specified buffer zone width in a direction that is constrained to lie within a local tangent space of the part surface at all points along the one or more part outer edge loops;
(f) extracting one or more buffer zone outer edge loops from the one or more buffer zone surfaces;
(g) generating one or more planar loops by projecting the one or more buffer zone outer edge loops onto an XY datum plane;
(h) computing a modified distance field, f;
(i) generating a reference surface comprising a plurality of reference x, y and calculated-z points that satisfy a condition that f=0; and
(j) manufacturing the part from a part sheet by using the generated reference surface with the sheet forming manufacturing process.

In an example, the non-transitory, computer-readable, digital storage medium can include instructions for defining the modified distance field, f according to Eq. (1), as follows:

$$f = {( x - \hat{x} )}^{2} + {( y - \hat{y} )}^{2} - {tan}^{2} ( {θ}_{c} ) {( z - \hat{z} )}^{2} \qquad Eq . ( 1 )$$

wherein, given a reference point with x, y, and (calculated) z reference coordinates, then \hat{x}, ŷ and \hat{z} equal the x, y, and z-coordinates, respectively, of a closest point from the reference point along the one or more buffer zone outer edge loops.
wherein if the x and y coordinates of a reference point lie outside of the one or more planar loops, then a corresponding z-coordinate value equals a calculated z-coordinate value that satisfies the condition that f=0;
wherein if one or more calculated z-coordinates satisfy the condition that f=0, for a given reference point with x and y coordinates, then the corresponding z-coordinate equals a minimum z-coordinate value selected from the one or more calculated z-coordinates;
wherein if no z-coordinate satisfies the condition that f=0, for a given reference point with x and y coordinates, then the calculated z-coordinate value equals a z-coordinate value that minimizes the modified distance field, f; and
wherein if the x and y coordinates are located inside of the planar loop, then calculate a point of intersection between a vertical line, having the same x and y coordinates as the reference point, and the part surface and buffer zone surface(s), wherein the calculated z-coordinate is equal to the z-coordinate value of the point of intersection.

In an example, the non-transitory, computer-readable, digital storage medium can further include computer instructions for:
(1) inputting a user-specified buffer zone width that is greater than or equal to zero;
(2) inputting a user-specified constant design wall angle θ_{c} for an addendum surface;
(3) inputting a user-specified Z-trimming coordinate;
(4) constructing a trimming plane at the user-specified Z-trimming coordinate; and
(5) removing a lower portion of the reference surface that lies below the user-specified trimming plane;
(6) selecting a smoothing option, and inputting a weighting factor when smoothing is selected:
(7) generating a smoothed reference surface;
(8) generating a stylus Z-level toolpath based on the smoothed and trimmed reference surface; and
(9) exporting the stylus Z-level toolpath in a Computer Numerically Controlled (CNC) format that is compatible with a controller that controls operation of an incremental sheet forming (ISF) machine. In an example, the non-transitory, computer-readable, digital storage medium further includes computer instructions for using a Two-Point Incremental Forming (TPIF) machine.

### BRIEF DESCRIPTION OF THE DRAWINGS

FIG. 1A shows a schematic perspective view of an example of Single Point Incremental Forming (SPIF).

FIG. 1B shows a schematic perspective view of an example of Two-Point Incremental Forming (TPIF) with a male underform tool.

FIG. 1C shows a schematic perspective view of an example of Two-Point Incremental Forming (TPIF) with a female underform tool.

FIG. 1D shows a schematic perspective view of an example of Dual-Sided Incremental Forming (DSIF) with a pair of opposing stylus tools.

FIG. 2A shows a schematic cut-away perspective view of an example of two-point incremental forming a part over a hemispherical male underform tool, illustrating the reduction in wall thickness, t, as a function of increasing wall angle (θ).

FIG. 2B shows a schematic cross-sectional perspective view of an example of TPIF of a part over a truncated conical male underform tool, illustrating a constant (reduced) wall thickness on the sloped portion of the tool, according to the present disclosure.

FIG. 3A shows a schematic perspective view of an example of an addendum surface generated by extending the part outer edge loop outwards and downwards at an angle of 45° with respect to the Z-axis, illustrating multiple regions of self-intersection, according to the present disclosure.

FIG. 3B shows a schematic perspective view of an example of a reference surface mesh generated using the currently disclosed method, wherein the reference surface mesh comprises an addendum surface that is free from self-intersections, according to the present disclosure.

FIG. 4A shows a first section of an example of a flow chart illustrating sequential steps for generating a reference surface for use with sheet forming, according to the present disclosure.

FIG. 4B shows a second section of an example of a flow chart illustrating sequential steps for generating a reference surface for use with sheet forming, according to the present disclosure.

FIG. 4C shows a third section of an example of a flow chart illustrating sequential steps for generating a reference surface for use with sheet forming, according to the present disclosure.

FIG. 4D shows a fourth section of an example of a flow chart illustrating sequential steps for generating a reference surface for use with sheet forming, according to the present disclosure.

FIG. 5 shows a schematic perspective view of an example of a part, a part edge loop, a contiguous buffer zone surrounding the perimeter of the part, and one or more buffer zone outer edge loops, along with an example of a level set surface surrounding the one or more buffer zone outer edge loops, made by setting a standard distance field formulation, f_{std}, equal to d, according to the present disclosure.

FIG. 6 shows a schematic perspective view of an example of: a part, a part edge loop, a contiguous buffer zone surrounding the perimeter of the part, and one or more buffer zone outer edge loops, along with an example of a level set surface surrounding the one or more buffer zone outer edge loops, made by setting a modified distance field formulation, f, equal to zero, according to the present disclosure.

FIG. 7 shows a schematic perspective view of an example of: a part, a part edge loop, a contiguous buffer zone surrounding the perimeter of the part, and one or more buffer zone outer edge loops as well as their respective projections onto an XY plane, according to the present disclosure.

FIG. 8 shows a schematic plan (top) view of an example of: a part, a part edge loop, a contiguous buffer zone surrounding the perimeter of the part, and one or more buffer zone outer edge loops, according to the present disclosure.

FIG. 9 shows a schematic perspective view of an example of: a part, a part edge loop, a contiguous buffer zone surrounding the perimeter of the part, and one or more buffer zone outer edge loops, two points on the part edge loop P and Q and their respective local tangent spaces, according to the present disclosure.

FIG. 10 shows a schematic perspective view of an example of: a part, a part edge loop, a contiguous buffer zone surrounding the perimeter of the part, and one or more buffer zone outer edge loops, located above a Cartesian grid of (X, Y) points in the XY plane, according to the present disclosure.

FIG. 11 shows a schematic perspective view of an example of a part, a part edge loop, a contiguous buffer zone surrounding the perimeter of the part, and one or more buffer zone outer edge loops, located above a Cartesian grid of (X, Y) points in the XY plane, illustrating a pair of candidate reference surface points which have X and Y coordinates that locate the points outside of the projected planar loop in the XY plane, according to the present disclosure.

FIG. 12 shows a schematic perspective view of an example of: a part, a part edge loop, a contiguous buffer zone surrounding the perimeter of the part, and one or more buffer zone outer edge loops, located above a Cartesian grid of (X, Y) points in the XY plane, illustrating a reference surface point, Rᵢ, which has X and Y coordinates that locate the point inside of the projected planar loop on the XY plane, according to the present disclosure.

FIG. 13 shows a schematic perspective view of an example of an unsmoothed reference surface mesh generated using the currently disclosed method, with a user-specified constant design wall angle θ_{c}=60°.

FIG. 14 shows a schematic perspective view of an example of a smoothed reference surface generated using the currently disclosed method, with a user-specified constant design wall angle, θ_{c}=60°.

FIG. 15 shows a schematic perspective view of an example of a smoothed reference surface generated using the currently disclosed method, with a user-specified constant design wall angle, θ_{c}=45°.

FIG. 16 shows a schematic perspective view of an example of a smoothed reference surface generated using the currently disclosed method, with a user-specified constant design wall angle, θ_{c}=30°.

FIG. 17A shows a schematic plan (top) view comparing three different examples of reference surfaces generated with three different user-specified constant design wall angles, θ_{c}=30°, 45°, and 60°, using the currently disclosed method.

FIG. 17B shows a schematic cut-away elevation (side) view (Section A-A) comparing three different examples of reference surfaces generated with three different user-specified constant design wall angles, θ_{c}=30°, 45°, and 60°, using the currently disclosed method.

FIG. 18 shows a schematic perspective view of an example of a reference surface generated using the currently disclosed method with a trimming plane that is parallel to an XY datum plane at a user specified Z coordinate.

FIG. 19 shows a schematic cut-away elevation (side) view of three different examples of reference surfaces generated using the currently disclosed method, all with the same user-specified constant design wall angle, θ_{c}=600 but with differing numbers of smoothing iterations.

FIG. 20A shows a schematic perspective view of an example of an unsmoothed reference surface generated using the currently disclosed method, without smoothing iterations being applied.

FIG. 20B shows a schematic perspective view of an example of a smoothed reference surface, generated using the currently disclosed method, with 50 smoothing iterations being applied.

FIG. 21A shows a schematic perspective view of an example of a reference surface for a branched part, generated using the currently disclosed method, with a constant design wall angle, θ_{c}=45°.

FIG. 21B shows a schematic perspective view of an example of a reference surface for a branched part, generated using the currently disclosed method, with a constant design wall angle, θ_{c}=60°.

FIG. 22A shows a schematic perspective view of an example of a reference surface generated for an omega-shaped part, using the currently disclosed method, with a constant design wall angle, θ_{c}=30°.

FIG. 22B shows a schematic perspective view of an example of a reference surface generated for the omega-shaped part, using the currently disclosed method, with a constant design wall angle, θ_{c}=45°.

FIG. 22C shows a schematic perspective view of an example of a reference surface generated for the omega-shaped part using the currently disclosed method, with a constant design wall angle, θ_{c}=60°.

FIG. 23 shows a schematic perspective view of an example of an ISF machine that comprises a multi-axis, CNC sheet forming arm controlled by a motion controller that moves a stylus tool along a generated stylus toolpath during sheet forming operations, according to the present disclosure.

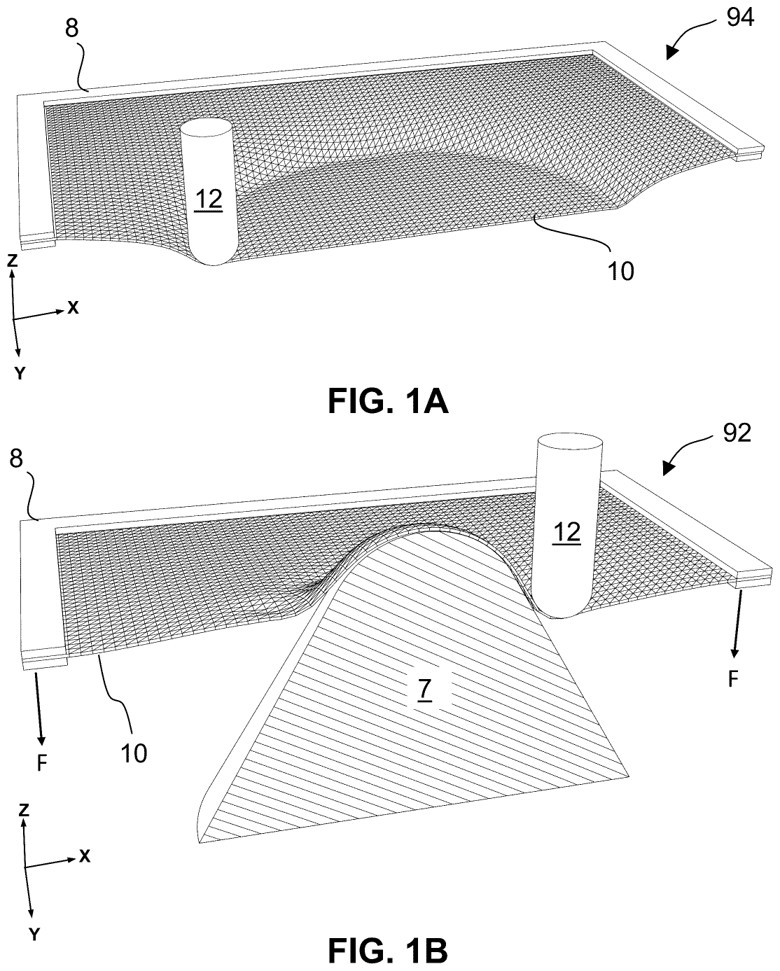

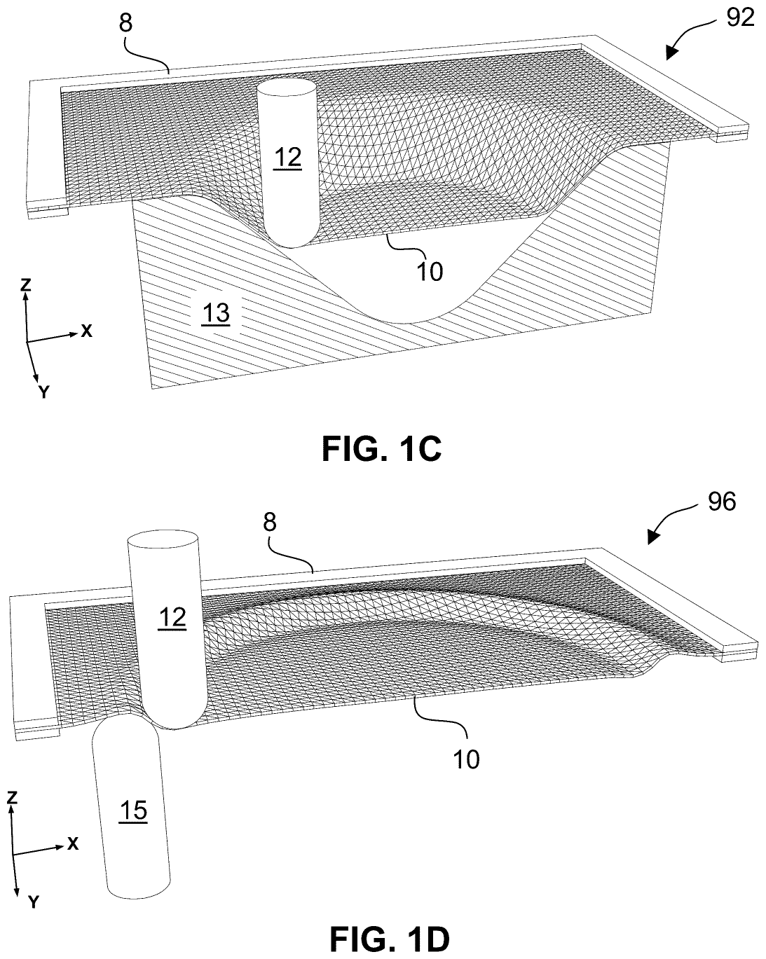

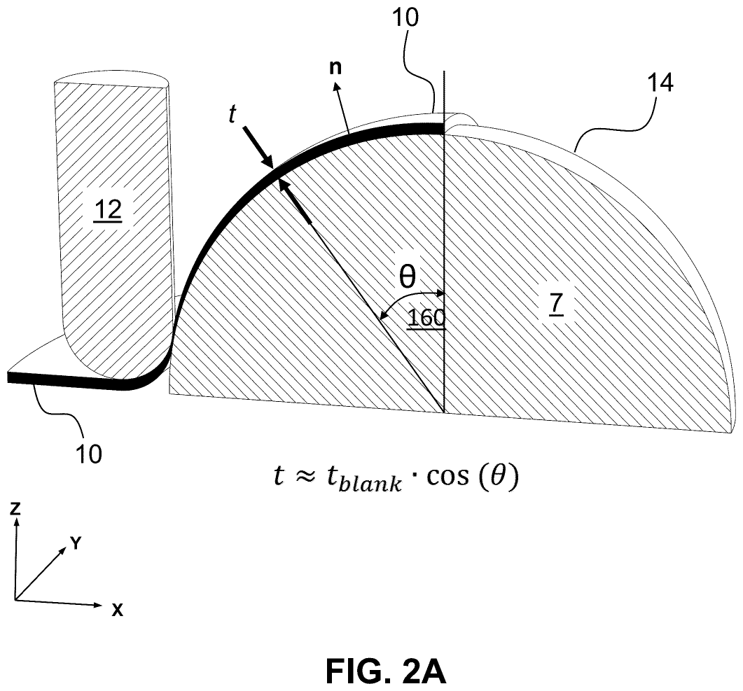

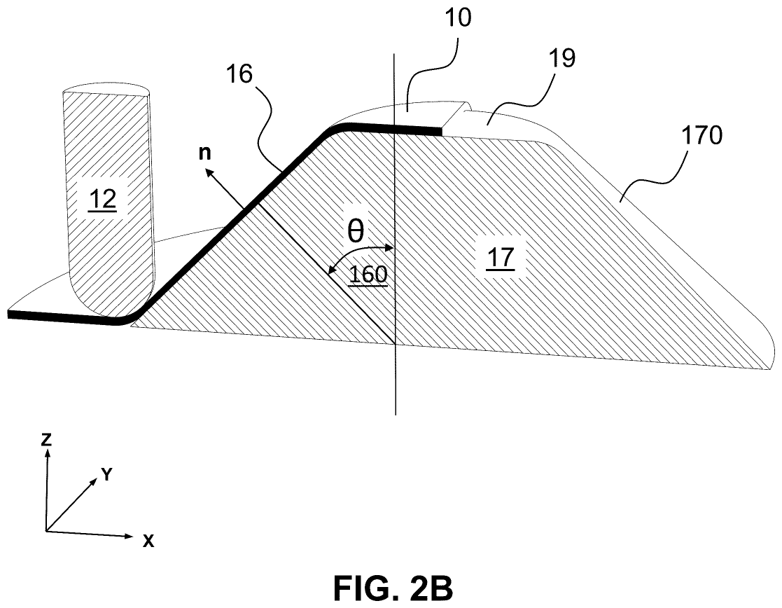

### DETAILED DESCRIPTION

This disclosure includes examples in many different forms. Representative examples of the disclosure are shown in the Drawings and will herein be described in detail with the understanding that these examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the Claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, can each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., can be with respect to a sheet forming machine.

The present disclosure gives examples of ISF machines that have a stylus tool aligned normal to a sheet blank. The present disclosure assumes a coordinate system with the Z-axis aligned with the centerline of the stylus tool and the sheet blank configured to be normal to this, lying in an X-Y plane of constant Z-coordinate. However, other orientations of the ISF process can be used. For example, the sheet blank can be clamped in a vertical position aligned with the ZX plane. The stylus tool would then be mounted in alignment with the Y axis and so forth. The drawings are not necessarily drawn to scale, but, rather, are schematic drawings that illustrate the geometrical relationships between elements and objects.

The phrase “reference surface” means the union of the following surfaces: (a) the part surface, (b) a contiguous buffer zone surface (if present), and (c) a contiguous addendum surface. The term “fixed-angle addendum surface” means an addendum surface that has a constant (fixed) wall angle, θ_{c}, with respect to the Z-axis. The term “sheet blank” means a blank sheet of metal or deformable material, before it is deformed by a sheet forming or ISF process. The phrases “underform tool”, “underform tooling”, and “underform die” are all used interchangeably. The word “elastoplastically” refers to the response of a metal during sheet forming or ISF processes, wherein the response comprises two components: (1) an elastic, non-permanent deformation (including elastic springback when the stylus tool is lifted off from the sheet blank), and (2) a plastic, permanent deformation occurring when a yield strength of the sheet material has been exceeded.

In general, an ISF machine typically comprises a collet that is used to hold a stylus tool, servomotors to facilitate controlled movement in three or more degrees of freedom, and a controller to interpret CNC instructions that drive the motors accordingly. Additionally, ball screws or the like are used to convert rotary motion of the motors into linear movements of the collet, which holds the stylus tool.

The fully-automated, computerized method of generating a reference surface, disclosed herein, speeds up the CAD modelling process from many hours or days down to typically less than one minute when executed on modern computer hardware. The present method thereby saves time when generating a reference surface, which is needed to generate an ISF stylus toolpath and, optionally, to generate underform tooling.

The sheet metal blanks that are used in sheet metal forming process can comprise any plastically deformable metals and their alloys. Examples include, but are not limited to: commercially pure aluminum, aluminum alloys (e.g. 2024, 2219, 5005, 5083, 6061 and 7075), steel, stainless steel alloys (e.g. 17-4), deep draw stainless steel alloys (e.g. 304D), commercially pure titanium (e.g. CP1, CP2), titanium alloys (e.g. Ti-6A14V), pure copper, brass alloys, bronze alloys, magnesium (AZ31), nickel alloys (e.g. Inconel 718) or combinations thereof.

ISF can be used to generate replacement sheet metal parts, such as aircraft skin panels, where the production run of conventionally formed panels has ended and no such replacement parts are available. Moreover, ISF can be used to rapidly generate a sheet metal repair patch (175) having a shape and form suitable for an aircraft panel repair. ISF is well suited for working with many annealed aluminum alloys, such as 2024-O and 7075-O, which, once heat treated after forming, are suitable for part replacement or repair in many aging aircraft platforms.

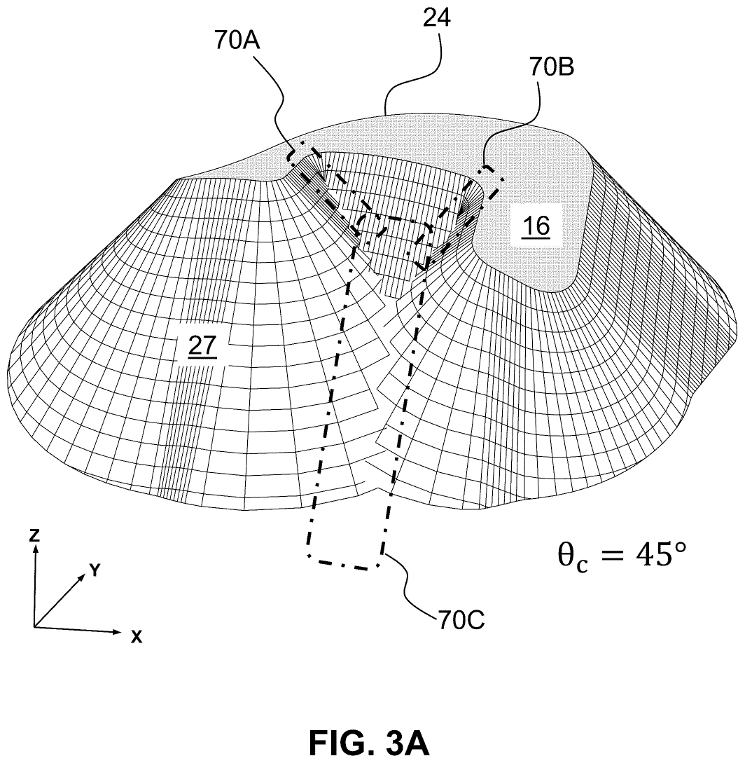

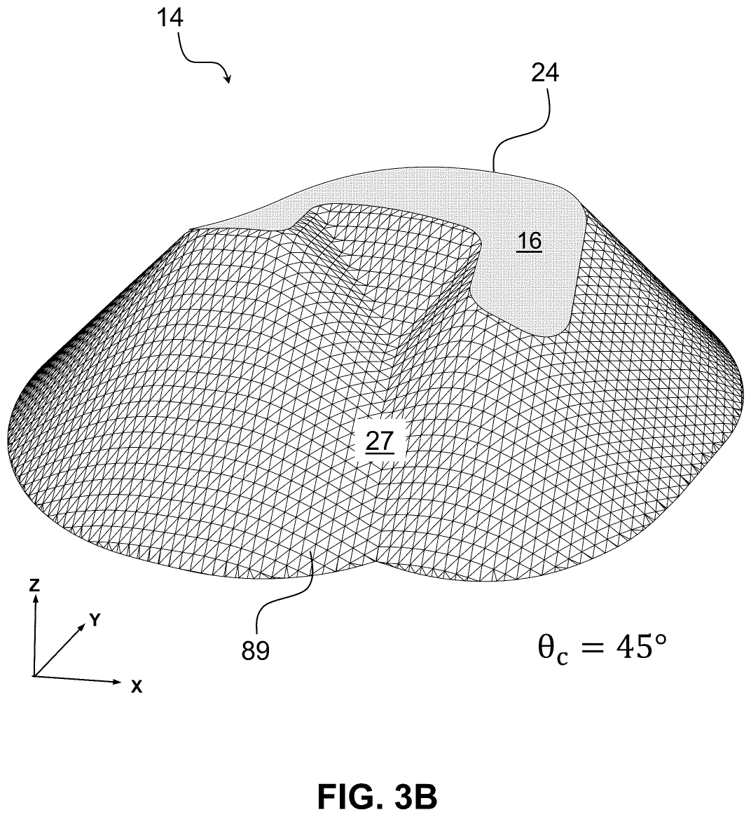

FIG. 3A shows a schematic perspective view of an example of an addendum surface 27, generated by extending the part outer edge loop 24 of sheet metal part 16 outwards and downwards as a straight line at an angle of 45° with respect to the Z-axis. FIG. 3A illustrates three regions of self-intersection: 70A, 70B, and 70C in the resulting addendum surface 27, exemplifying why it is not always possible to simply extend a surface boundary in this way to construct an addendum surface 27 with a constant design wall angle 88, θ_{c} that is free from self-intersections.

FIG. 3B shows a schematic perspective view of an example reference surface 14 generated using the currently disclosed method, and which includes an addendum surface 27 with a constant (fixed) wall angle 88 of θ_{c}=45°, according to the present disclosure. Sheet metal part 16 illustrated in FIG. 3B is identical to that shown in FIG. 3A. However, in FIG. 3B, the surface geometry generated according to the present disclosure does not intersect with itself. Addendum surface 27 has a fixed slope everywhere along its surface. Addendum surface 27 can also be described as a “skirt” that surrounds and extends away from the sheet metal part surface 16.

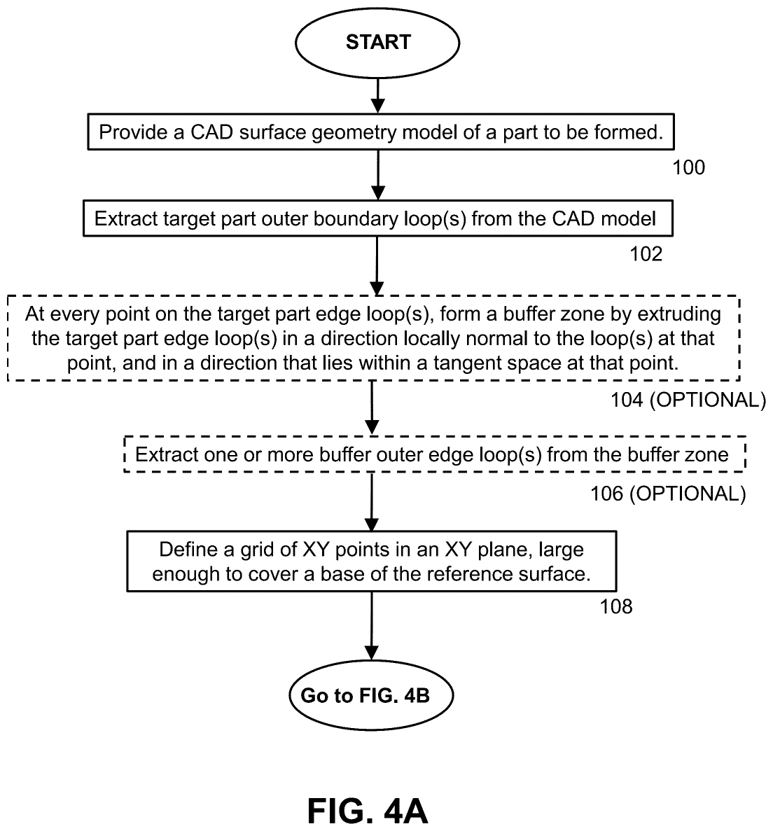

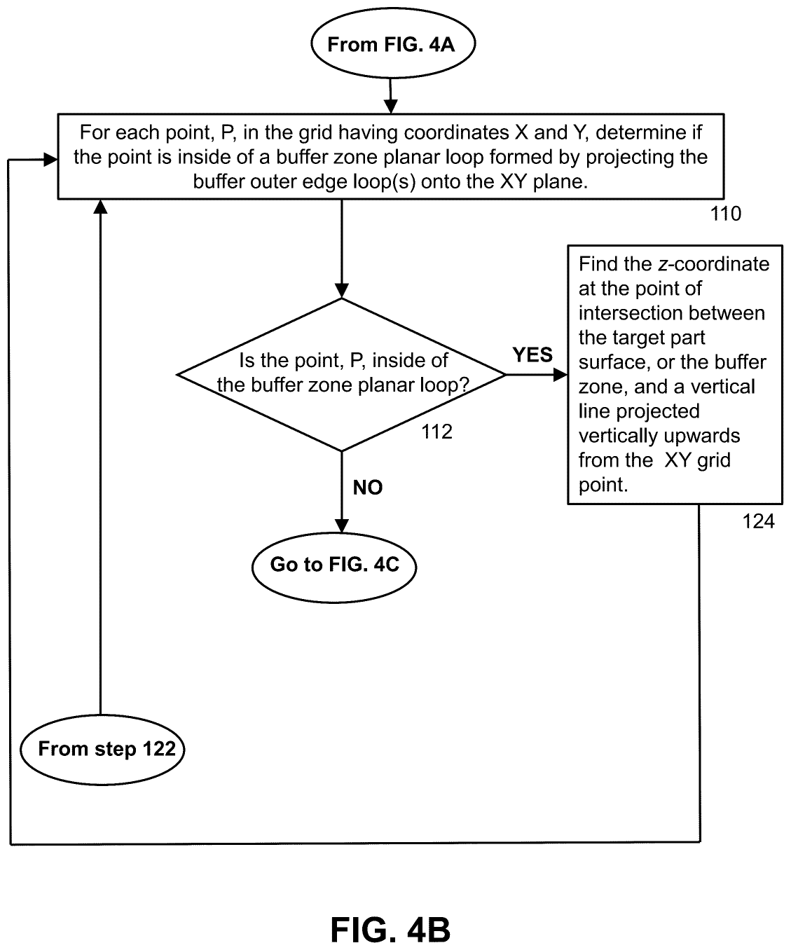

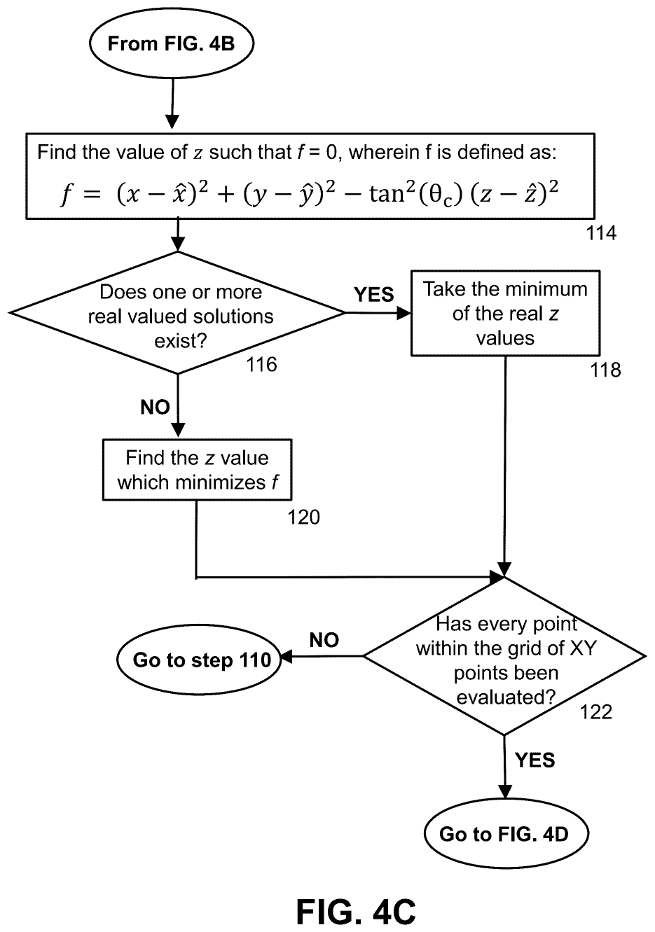

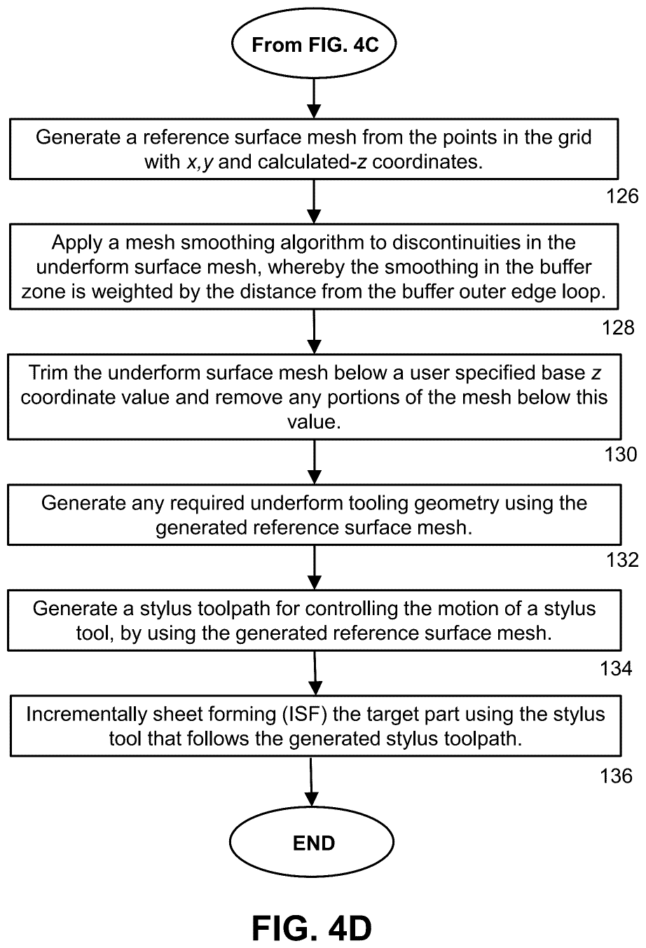

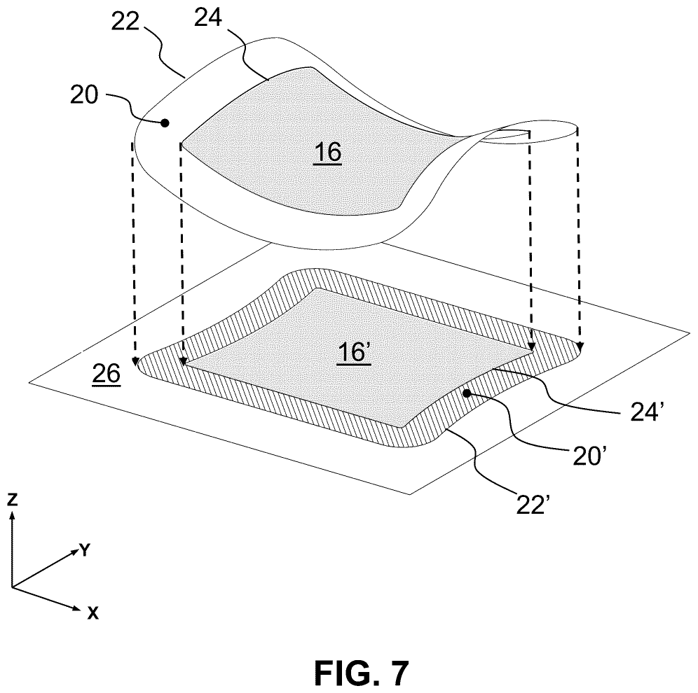

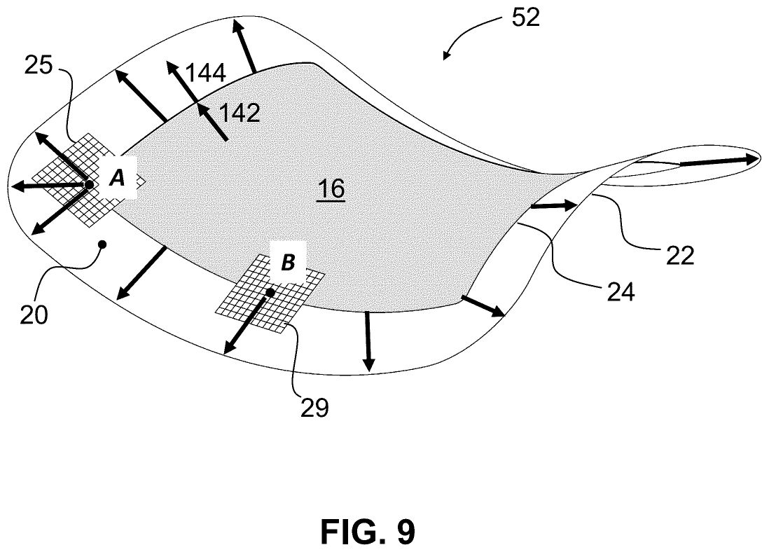

In general, reference surface 14 can comprise a surface mesh of quadrilateral elements, triangular elements, or combinations thereof. FIG. 4A shows a first section of an example of a flow chart illustrating sequential steps for generating a reference surface for use by a sheet forming machine, according to the present disclosure. Step 100 comprises providing a geometrical representation 60 of a target part in the form of a CAD surface geometry model 52. Next, step 102 comprises extracting one or more part outer boundary loop(s) from the CAD surface geometry model. Next, optional step 104 comprises: at every point on the part outer edge loop(s), forming a contiguous buffer zone by extending the part outer boundary loop(s) in a direction locally perpendicular to a planar edge loop(s) at that point (see item 22′ in FIG. 7), and in a direction that lies within a local tangent space at that point (e.g., see item 25 of FIG. 9). Next, optional step 106 comprises extracting one or more buffer zone outer edge loops from the buffer zone. Next, step 108 comprises defining a grid of XY points lying in an XY datum plane, wherein the grid is large enough to cover a base of the reference surface.

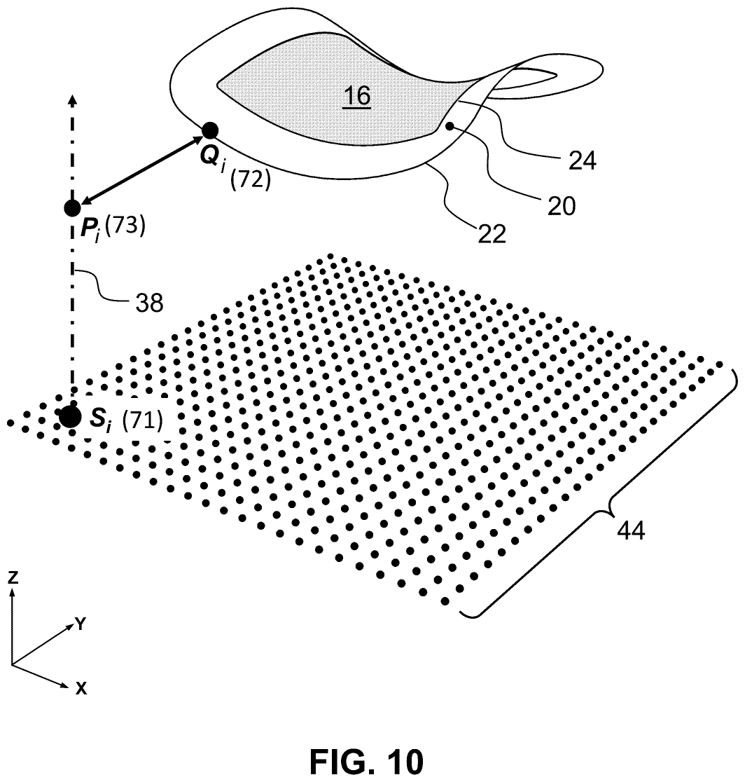

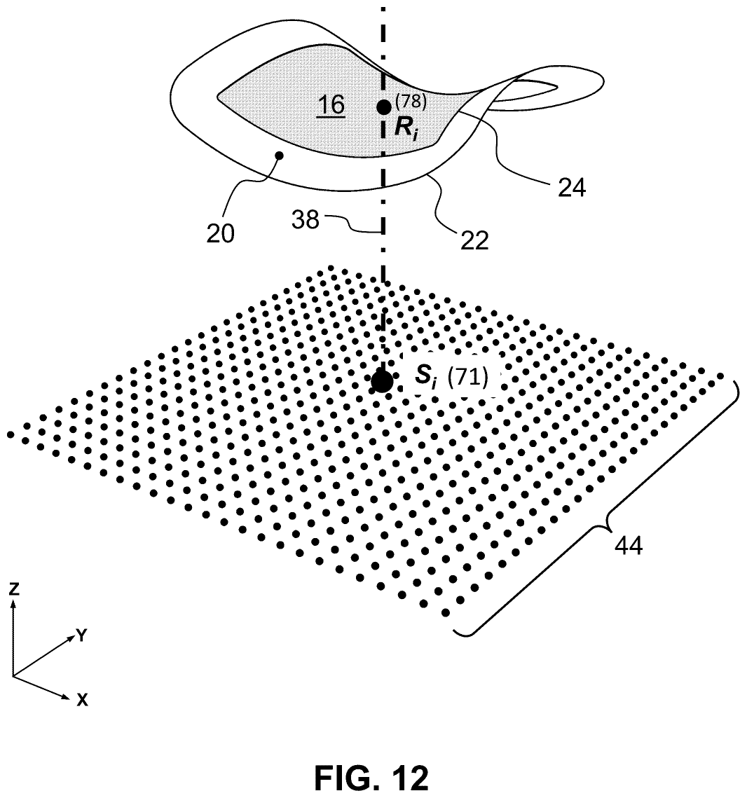

FIG. 4B shows a second section of the example of a flow chart illustrating sequential steps for generating a reference surface for use by a sheet forming machine, according to the present disclosure. Continuing on from FIG. 4A, step 110 comprises: for each reference point, P, (See item 73 in FIG. 10) in the XY grid having coordinates (X, Y), determining if the reference point, P, is inside of a buffer zone planar loop that is formed by projecting the one or more buffer zone outer edge loops onto the XY datum plane or, if no buffer surface exists, determining if the reference point, P, is inside of a part planar loop that is formed by projecting the part edge loop(s) onto the XY datum plane 26. Next, step 112 asks if the point, P, lies inside of the planar loop. If the answer to step 112 is “YES”, then go to step 124. Step 124 comprises finding a Z-coordinate at a point of intersection 78 (see FIG. 12) between the part surface and buffer zone surface(s) and a vertical line 38 (see FIG. 12) projected vertically upwards from the XY grid point. If the answer to step 112 is “NO”, then go to step 114 in FIG. 4C.

FIG. 4C shows a third section of the example of a flow chart illustrating sequential steps for generating a reference surface for use by a sheet forming machine, according to the present disclosure. Step 114 comprises finding a value of z such that f=0, wherein f is defined as a modified distance field, as follows:

$$f = {( x - \hat{x} )}^{2} + {( y - \hat{y} )}^{2} - {tan}^{2} ( {θ}_{c} ) {( z - \hat{z} )}^{2} \qquad Eq . ( 1 )$$

wherein:
x equals the X coordinate of reference point P;
y equals the Y coordinate of reference point P;
z equals the Z-coordinate of reference point P (the value which must be calculated);
\hat{x} equals the X coordinate of a closest point 72 (see FIG. 10) along the one or more buffer zone outer edge loops;
ŷ equals the Y coordinate of the closest point 72 along the one or more buffer zone outer edge loops; and \hat{z} equals the Z-coordinate of the closest point 72 along the one or more buffer zone outer edge loops. Step 114 can use a secant method 84 to efficiently solve Eq. (1) for a z-coordinate value, given x and y coordinate values, such that the modified distance field, f (68), equals zero. Continuing on, step 116 asks if one or more real-valued solutions 86 exist for Eq. (1) for the given x and y coordinates of reference point P. If the answer to step 116 is “YES”, then go to step 118. Step 118 comprises calculating a minimum of the of the real-valued z-coordinate solutions. If the answer to step 116 is “NO”, then go to step 120. Step 120 comprises calculating a z-coordinate value which minimizes f Step 120 can use an optimization algorithm 81 for this, such as a Nelder-Mead optimization algorithm 83. Next, step 122 comprises asking if every point within the grid of XY points has been evaluated. If the answer to step 122 is “YES”, then go to step 126 in FIG. 4D. If the answer to step 122 is “NO” then go back to step 110 and repeat steps 110, 112, 114 or 124 for a different XY grid point.

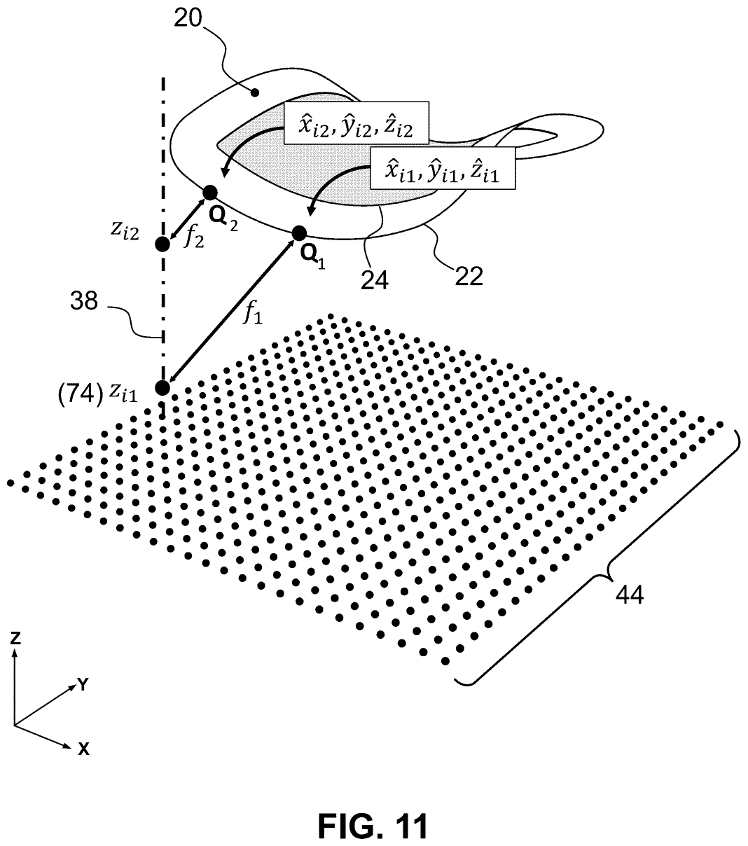

FIG. 4D shows a fourth section of an example of a flow chart illustrating sequential steps for generating a reference surface for use by a sheet forming machine, according to the present disclosure. Continuing on from FIG. 4C, step 126 comprises generating a reference surface mesh from the points in the XY grid with given x, y coordinates and calculated z-coordinates 74 (see FIG. 11) to form a reference surface mesh of quadrilateral and/or triangular elements 89 (see FIG. 3B and FIG. 11). Next, step 128 comprises removing geometrical discontinuities in the generated reference surface. A Laplace, Laplace-Beltrami, or Taubin mesh smoothing algorithm 85 can be used. A weighting factor 87 can be used to control the amount of mesh smoothing. In some examples, the weighting factor 87 can equal the exponential of negative-one multiplied by a user-specified constant further multiplied by a distance (optionally a planar distance in the XY datum plane) between a grid point on the XY datum plane and a closest point 72 on the one or more buffer zone outer edge loops. Many iterations of smoothing are typically required to generate an acceptably-curved corner (e.g., 25-100 iterations).

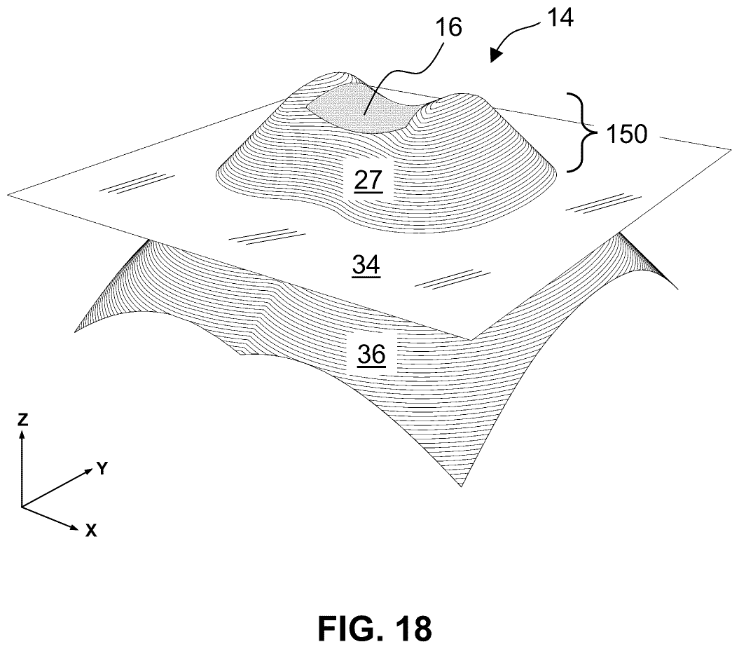

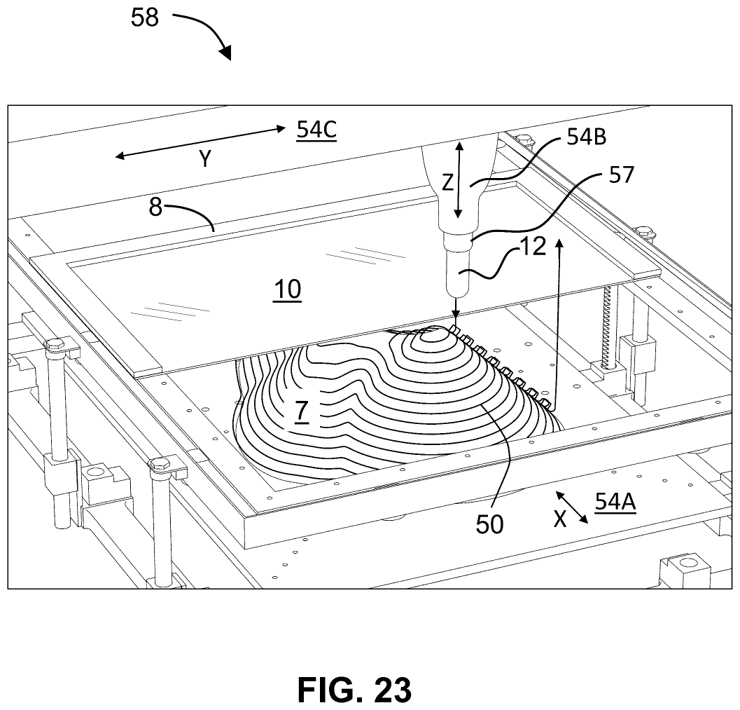

Referring still to FIG. 4D, next step 130 comprises trimming off portions 36 of the reference surface mesh 14 that lie below a trimming plane 34 (see FIG. 18) defined by user-specified Z-trimming coordinate 99. Next, step 132 involves the generation of an optional underform tool surface geometry 170 from the generated reference surface mesh, if needed. Then, step 134 comprises generating one or more ISF stylus Z-level toolpaths 50 (See FIG. 23) that controls the motion of an ISF stylus tool 12 by using the generated reference surface mesh 16. Finally, step 136 comprises incrementally sheet forming the sheet metal part 16 using one or more stylus tools 12, 15 that follow the one or more generated stylus Z-level toolpath(s) 50.

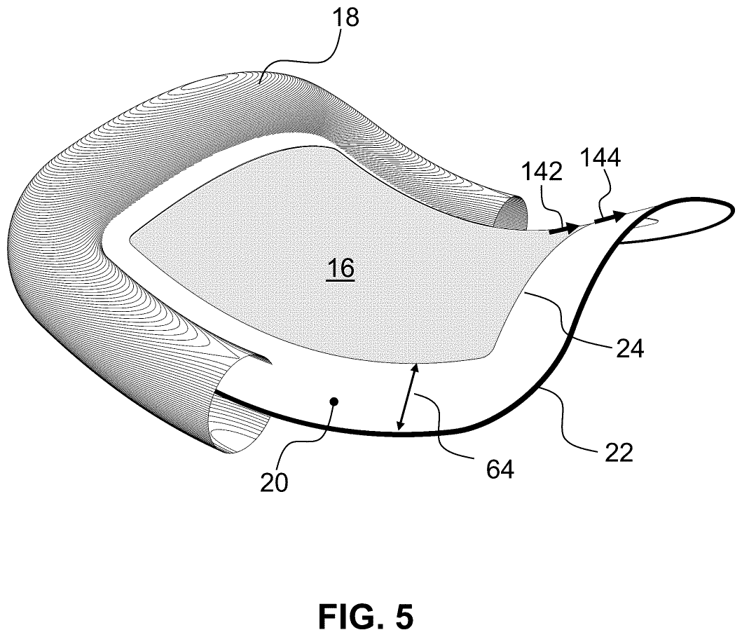

FIG. 5 shows a schematic perspective view of an example of a sheet metal part 16 to be formed, one or more part edge loop(s) 24, a contiguous buffer zone 20 surrounding the perimeter of sheet metal part 16, and one or more buffer zone outer edge loops 22, according to the present disclosure. As detailed more in FIG. 9, buffer zone surface 20 has a geometry that ensures it matches the edge slope 142 of sheet metal part 16 to the corresponding, adjacent edge slope 144 of buffer zone surface 20, along the one or more part edge loop(s) 24, in order to improve formability. FIG. 5 also shows an example of a level set surface 18 that surrounds the one or more buffer zone outer edge loops 22. Note that the right half of level set surface 18 has been cut away for clarity. The level set surface 18 is a level set 82 of the standard distance field, f_{std}, with a specified distance parameter d wherein f_{std} is also set equal to zero. The level set surface 18 comprises a level set 82 of all points that are d units away from the one or more buffer zone outer edge loops 22. The standard distance field, f_{std}, is given by Eq. (2), as follows:

$${f}_{std} = {( x - \hat{x} )}^{2} + {( y - \hat{y} )}^{2} + {( z - \hat{z} )}^{2} - {d}^{2} \qquad Eq . ( 2 )$$

The difference between the modified distance field, f (68) (given by Eq. (1)) and the standard distance field, f_{std}, (given by Eq. (2)) is that the term (z−\hat{z})² is weighted by a constant factor equal to −tan²(θ), and that the distance parameter, d, is set equal to zero in Eq. (2), giving only one possible level set 82.

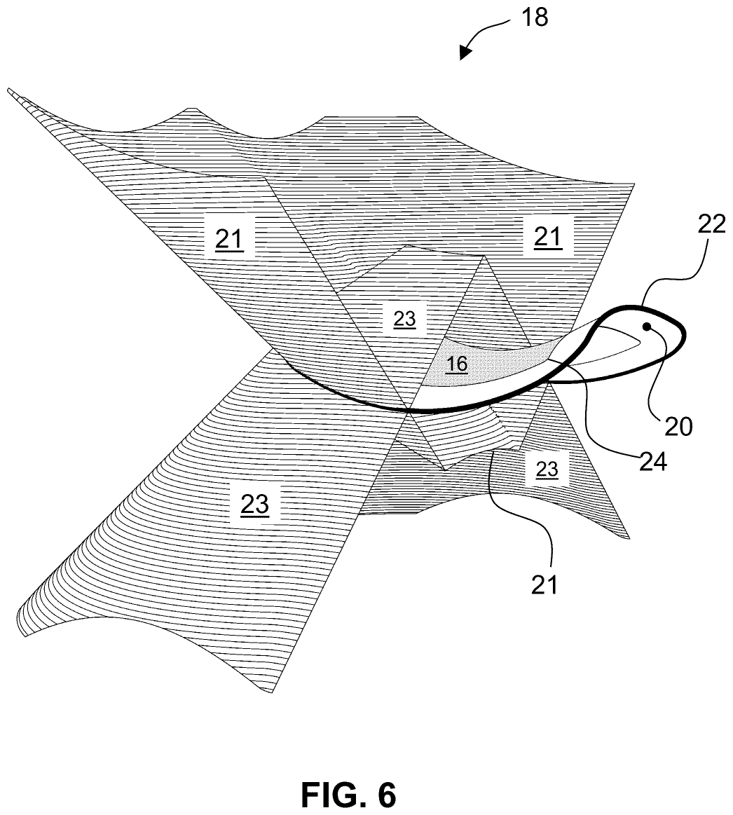

FIG. 6 shows a schematic perspective view of an example of a sheet metal part 16, one or more part edge loop(s) 24, a contiguous buffer zone 20 surrounding the perimeter of the sheet metal part 16, and one or more buffer zone outer edge loops 22, along with a level set surface 18 made up of two distinct portions 21 and 23, according to the present disclosure. The level set surface 18 shows all positions where the modified distance field, f (68), from Eq. (1), is equal to zero. In this figure, there is generally more than one solution of the calculated z-coordinate value 74 which corresponds to the same x and y coordinates.

FIG. 7 shows a schematic perspective view of an example of a sheet metal part 16, a part edge loop 24, a contiguous buffer zone 20 surrounding the perimeter of the sheet metal part 16, and one or more buffer zone outer edge loops 22, with a projected buffer planar loop 22′ that lies within XY datum plane 26, according to the present disclosure. Sheet metal part 16 is projected downwards onto the XY datum plane 26 to make projected sheet metal part 16′. Part edge loop 24 is projected downwards onto XY datum plane 26 to make projected part edge loop 24′. Buffer zone 20 is projected downwards onto XY datum plane 26 to make projected buffer zone 20′. Lastly, buffer zone outer edge loop 22 is projected downwards onto XY datum plane 26 to make projected buffer zone outer edge loop 22′. The term “planar loop” is equivalent to the projected buffer zone outer edge loop 22′ if the buffer zone surface is present, otherwise it represents the projected part edge loop 24′ if the user-specified buffer zone width 64 is set equal to zero.

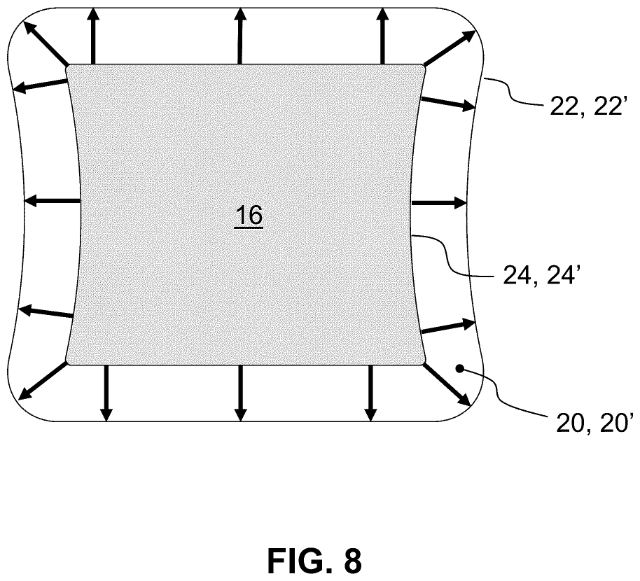

FIG. 8 shows a schematic plan view of an example of a sheet metal part 16, a part edge loop 24, a contiguous buffer zone 20 surrounding the perimeter of the sheet metal part 16, and one or more buffer zone outer edge loops 22, according to the present disclosure. The user-specified buffer zone width 64 can be zero (i.e., no buffer zone) or greater.

FIG. 9 shows a schematic perspective view of an example of a sheet metal part 16, one or more part edge loop(s) 24, a contiguous buffer zone 20 surrounding the perimeter of the sheet metal part 16, and one or more buffer zone outer edge loops 22, according to the present disclosure. A first plane 25 is shown, which corresponds to the local tangent space 66 of Point A of part outer edge loop 24, and a second plane 29 is shown which corresponds to the local tangent space 66 of point B of part outer edge loop 24. As previously presented, step 100 from FIG. 4A comprises providing a geometrical representation 60 of sheet metal part 16 in the form of a CAD surface geometry model 52 (e.g., a set of contiguous, trimmed parametric surfaces). The method disclosed herein extracts one or more part outer boundary loop(s) 24 from the CAD geometric model 52. Next, the method comprises, at every point on the part outer edge loop(s) 24, forming a contiguous buffer zone 20 by extending the sheet metal part 16 in a direction locally perpendicular to the projected part outer edge loop 24′ (see FIG. 7 and FIG. 8) at that point, and in a direction that lies within the local tangent space 66 at that point (e.g., plane 25 for Point A). Buffer zone surface 20 has a geometry that ensures it exactly matches the edge slope 142 of sheet metal part 16 to the corresponding adjacent edge slope 144 of buffer zone surface 20, along the one or more part edge loop(s) 24, in order to improve formability.

FIG. 10 shows a schematic perspective view of an example of a sheet metal part 16, one or more part edge loops 24, a contiguous buffer zone 20 surrounding the perimeter of the sheet metal part 16, and one or more buffer zone outer edge loops 22, sitting above a Cartesian grid 44 of XY points lying in the XY datum plane 26 (see FIG. 7), illustrating an i^{th} reference surface point 73, Pᵢ, that has x and y coordinates that locate it outside of the planar loop 22′ (see FIG. 7 and FIG. 8), according to the present disclosure. The closest point 72, Qᵢ, has coordinates (\hat{x}ᵢ, ŷᵢ, \hat{z}ᵢ) and represents the closest point 72 on the buffer edge outer loop 22 to the reference point 73, Pᵢ. The i^{th} reference point, 73, Pᵢ, has coordinates (xᵢ, yᵢ, zᵢ). The coordinates xᵢ and yᵢ of point Pᵢ are prescribed by the location within the XY grid 44, and zᵢ is calculated such that f=0, wherein z₁ equals the minimum all real-valued solutions 86 to Eq. (1) or, if no such point exists, then z₁ is calculated such that it minimizes a value of f for that combination of coordinates xᵢ and yᵢ. The i^{th} reference point 73, Pᵢ, is located on vertical line 38, which is projected vertically upwards from the i^{th} XY grid point 71, Sᵢ.

FIG. 11 shows a schematic perspective view of an example of a sheet metal part 16, one or more part edge loops 24, a contiguous buffer zone 20 surrounding the perimeter of the sheet metal part 16, and one or more buffer zone outer edge loops 22, above a Cartesian grid 44 of XY points in the XY datum plane 26 (see FIG. 7), illustrating candidate reference surface points, zᵢ₁ and zᵢ₂ that have X and Y coordinates which locate them outside of the planar loop 22′ (see FIG. 7 and FIG. 8), according to the present disclosure. Also shown are the respective closest points, Q₁ and Q₂, on the one or more buffer zone outer edge loops 22 for each of the candidate reference points. Because the loop point, Qᵢ, on buffer zone outer edge loop 22 can be located at any point along the one or more buffer zone outer edge loops 22, the coordinates \hat{x}ᵢ, ŷᵢ, \hat{z}ᵢ depend on the calculated value of zᵢ. Therefore, in general, the value of zᵢ cannot be solved for explicitly (i.e., one cannot use the quadratic formula to directly solve Eq. (1) for zᵢ because of the dependence of \hat{x}ᵢ, ŷᵢ, \hat{z}ᵢ on zᵢ). To solve this problem, an efficient way to determine the value of zᵢ which makes f=0 is to use a secant numerical solution method of finding all solutions of Eq. (1). The candidate reference points, zᵢ₁ and zᵢ₂, are located on vertical line 38, which is projected vertically upwards from the i^{th} XY grid point, Sᵢ. When more than one candidate reference point exists for given X and Y coordinates, the candidate reference point with the minimum z-coordinate value 76 is used.

FIG. 12 shows a schematic perspective view of an example of a sheet metal part 16, one or more part edge loops 24, a contiguous buffer zone 20 surrounding the perimeter of the sheet metal part 16, and one or more buffer zone outer edge loops 22, above a Cartesian grid 44 of XY points in the XY datum plane 26 (see FIG. 7), illustrating an i^{th} reference surface point, Rᵢ, that has x and y coordinates that locate it inside of the planar loop 22′ (see FIG. 7 and FIG. 8) according to the present disclosure. In this case, the value of zᵢ equals a point of intersection 78 between the sheet metal part 16, or the buffer zone 20, and a vertical line 38 that is projected vertically upwards from the i^{th} XY grid point, Sᵢ, 71. If the sheet metal part 16 comprises, for example, a mesh of triangles (not shown), then this intersection point, Rᵢ, can be interpolated from the coordinates of the three corner vertices of the intersected triangle, in combination with the xᵢ and yᵢ coordinates of the i^{th} XY grid point, Sᵢ, 71 In some examples, Barycentric coordinates can be used to provide a convenient way to compute a precise point of intersection 78 between the vertical line 38 and a mesh element 89, which is in the form of a triangle.

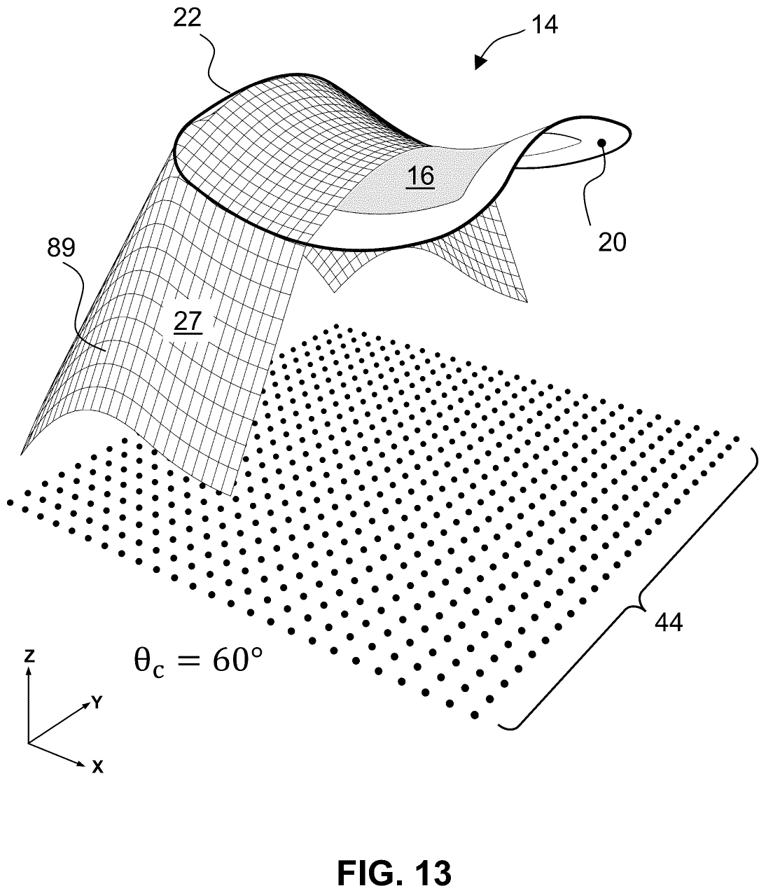

FIG. 13 shows a schematic perspective view of buffer zone outer edge loop 22 and an example of a reference surface 14, generated by the currently disclosed method, that includes an addendum surface 27. Reference surface 14 includes: addendum surface 27, buffer zone surface 20, and sheet metal part 16. In this example, addendum surface 27 has a user-specified constant design wall angle 88 of θ_{c}=60°. In this example, reference surface 14 has not been smoothed.

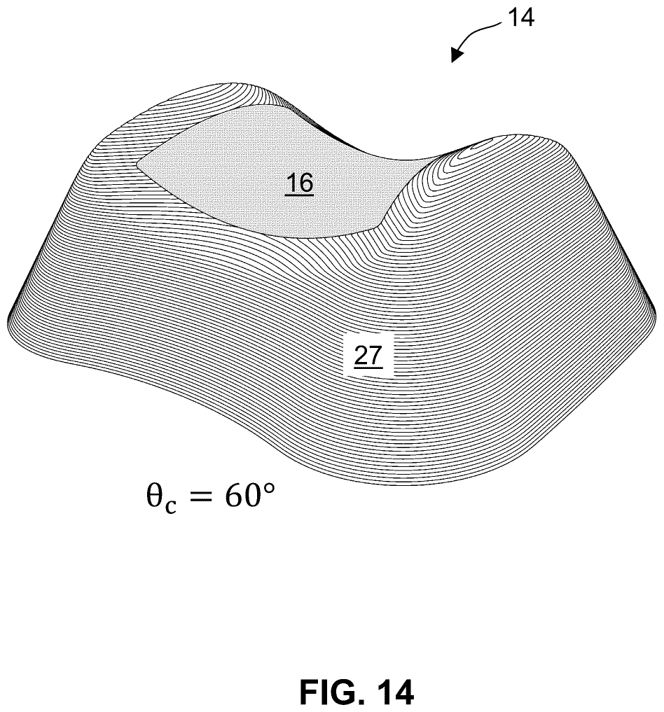

FIG. 14 shows a schematic perspective view of an example of a reference surface 14 for which sheet metal part 16 is coincident, and addendum surface 27, according to the present disclosure. The addendum portion 27 of reference surface 14 has a user-specified constant design wall angle 88 of θ_{c}=60°. In this example, reference surface 14 has been smoothed.

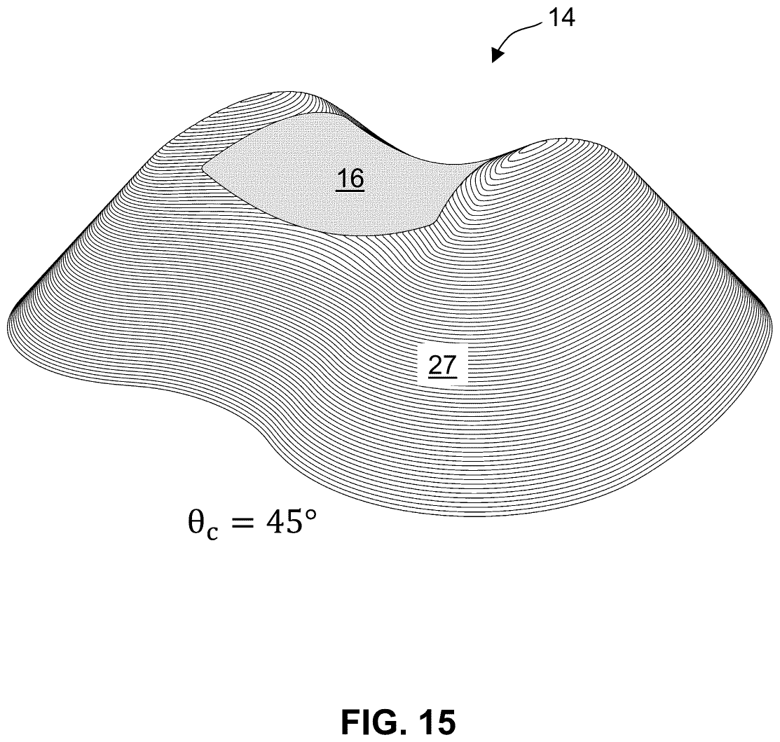

FIG. 15 shows a schematic perspective view of an example of a reference surface 14 for which sheet metal part 16 is coincident, according to the present disclosure. The addendum portion 27 of reference surface 14 has a user-specified constant design wall angle 88 of θ_{c}=45°. In this example, reference surface 14 has been smoothed.

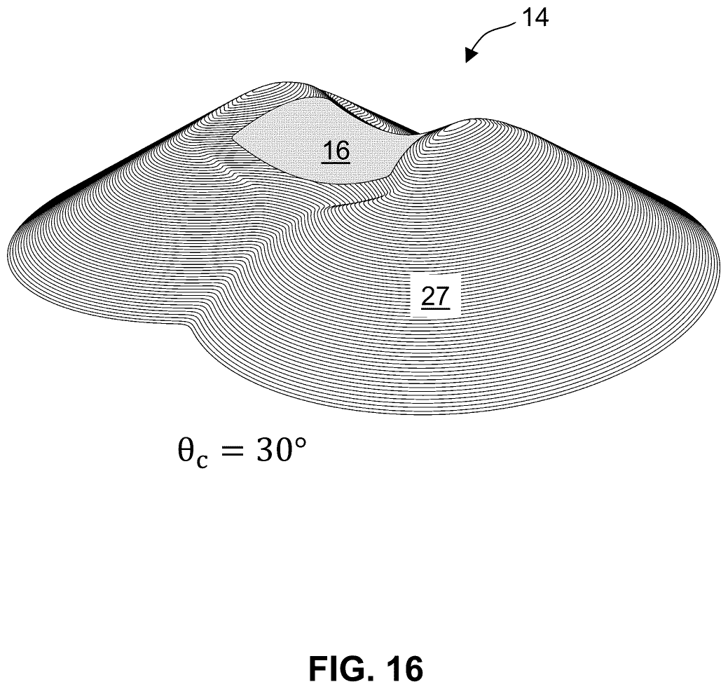

FIG. 16 shows a schematic perspective view of an example of a reference surface 14 for which sheet metal part 16 is coincident, according to the present disclosure. Addendum portion 27 of reference surface 14 has a user-specified constant design wall angle 88 of θ_{c}=30°. In this example, reference surface 14 has been smoothed.

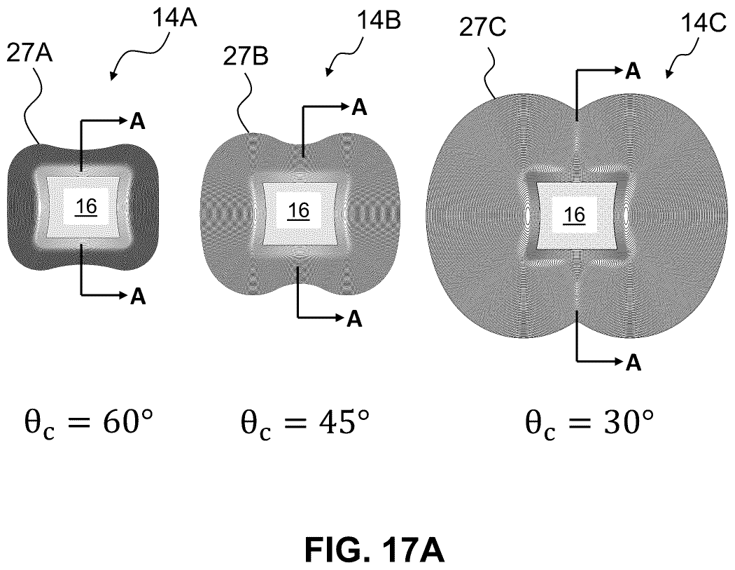

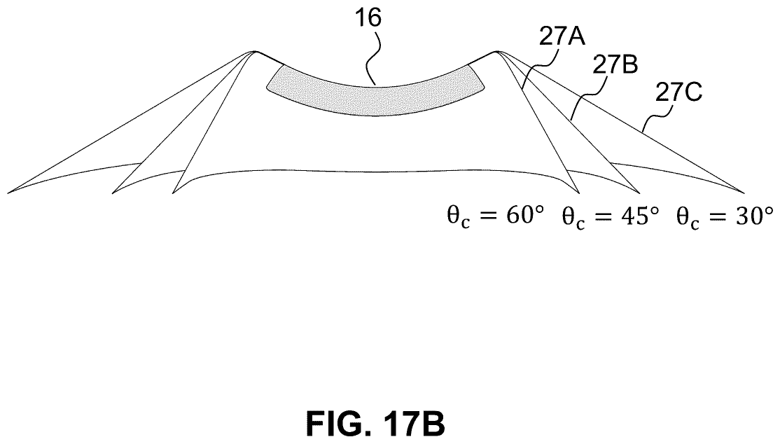

FIG. 17A shows a schematic plan (top) view comparing three different examples of reference surfaces 14A, 14B, and 14C generated by the presently disclosed method, of which sheet metal part 16 is coincident. Addendum surface 27A has a user-specified constant design wall angle 88 of θ_{c}=60°; addendum surface 27B has a user-specified constant design wall angle 88 of θ_{c}=45°; and addendum surface 27C has a user-specified constant design wall angle 88 of θ_{c}=30°. In general, the lower the user-specified constant design wall angle 88, θ_{c}, the larger the footprint is of addendum surface 27.

FIG. 17B shows a cut-away elevation (side) comparing three different examples of reference surfaces 14A, 14B and 14C, which include addendum surfaces 27A, 27B, and 27C respectively. Each of the reference surfaces were generated by the presently disclosed method and sheet metal part 16 is coincident with each surface. In this figure, only the portions of reference surfaces 14A, 14B and 14C that lie on one side of section plane A-A are shown in order to provide a cut away view. Addendum surface 27A has a user-specified constant design wall angle 88 of θ_{c}=60°, addendum surface 27B has a user-specified constant design wall angle 88 of θ_{c}=45°, and addendum surface 27C has a user-specified constant design wall angle 88 of θ_{c}=30°.

FIG. 18 shows a schematic perspective view illustrating an example of a reference surface 14, generated by the presently disclosed method, for which sheet metal part 16 is coincident, including a trimming plane 34 that is defined by a user-specified Z-trimming coordinate 99, according to the present disclosure. The lower portion(s) 36 of addendum surface 27 that lie below the trimming plane 34 can be removed from reference surface 14 by performing the trimming operation 130 of FIG. 4D. Removing the lower portion(s) 36 of addendum surface 27 in this way creates a trimmed reference surface 150 with a flat base 140 (not shown).

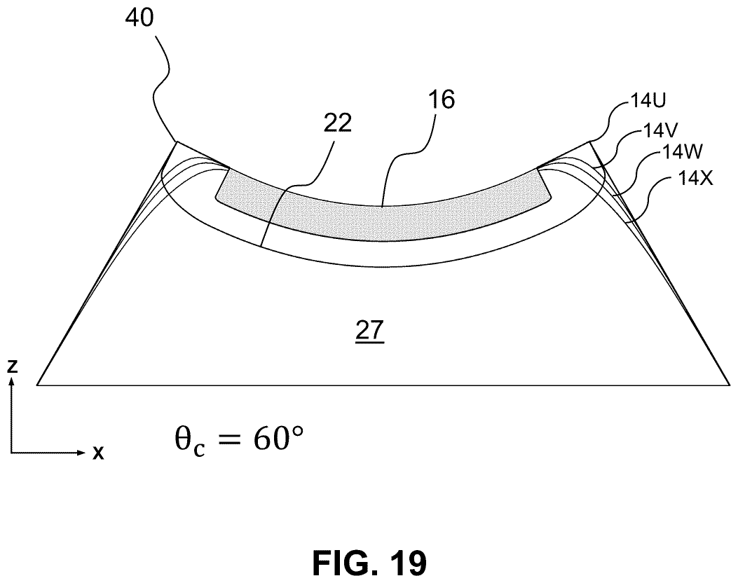

FIG. 19 shows a schematic cut-away elevation (side) view illustrating several examples reference surfaces 14U, 14V, 14W, and 14X generated using the currently disclosed method, and for which sheet metal part 16 is coincident. In general, with the presently disclosed method of reference surface generation, a wall angle discontinuity 40 may be present on buffer zone outer edge loop 22 (or on part outer edge loop 24, if no buffer zone surface is present) due to a step change in wall angle from the buffer zone surface 20 (or part surface 16) to the user-specified constant design wall angle 88, θ_{c} of addendum surface 27. In such cases of wall angle discontinuities 40, a mesh smoothing algorithm can be selectively applied to the discontinuous reference surface 14U. In some examples, this smoothing algorithm can comprise performing one or more of: a Laplace, a Laplace-Beltrami, or a Taubin mesh smoothing algorithm 85. These smoothing algorithms 85 typically require performing one or more iterations of smoothing to achieve a surface which is sufficiently smooth for successful forming operations.

Referring still to FIG. 19, reference surface 14U has not been smoothed, and has a sharp corner 40. Smoothed reference surface 14V is the result of 25 smoothing iterations. Smoothed reference surface 14W is the result of 50 smoothing iterations, and smoothed reference surface 14X is the result of 100 smoothing iterations. Increasing the number of smoothing iterations causes increased smoothness of the wall angle discontinuity 40, but can cause reference surface 14 to deviate its shape from the buffer zone surface 20 and, with further iterations of smoothing, part surface 62 of sheet metal part 16. The intent of generating buffer zone surface 20 is to provide a region which can deviate geometrically once smoothed, without having any effect on the geometry of sheet metal part 16 itself. Having a smooth surface generally improves formability in sheet forming or ISF manufacturing operations. The number of iterations of smoothing can be selected by the user to have good formability, while still maintaining a reference surface 14 for which sheet metal part 16 is coincident.

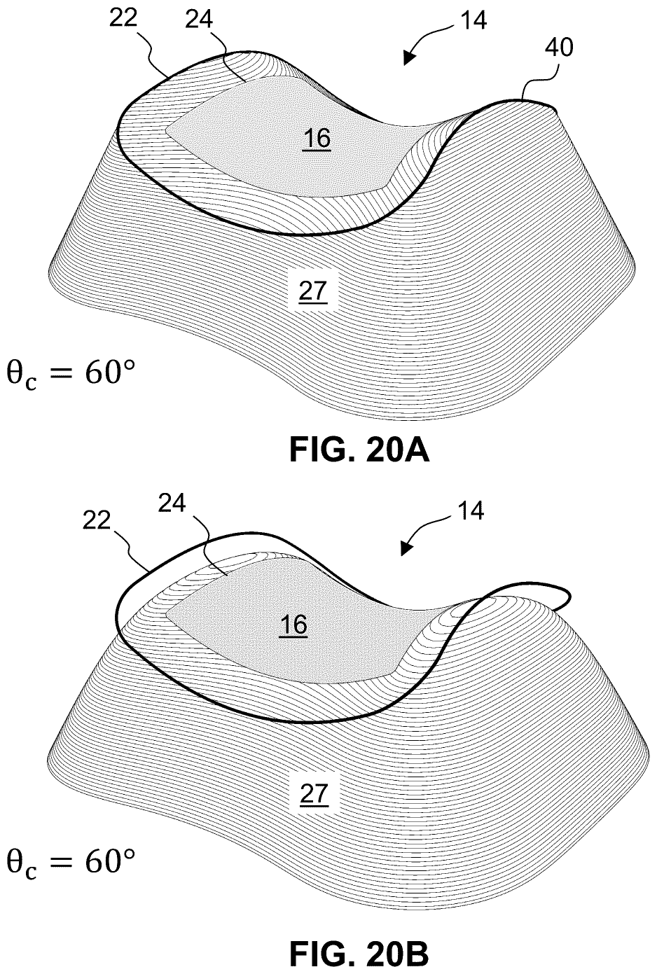

FIG. 20A shows a schematic perspective view of an example of a reference surface 14 generated using the currently disclosed method, for which sheet metal part 16 is coincident. The reference surface 14 has a slope discontinuity 40 because no smoothing has been applied.

FIG. 20B shows a schematic perspective view of an example of a reference surface 14 generated using the currently disclosed method, for which sheet metal part 16 is coincident. Reference surface 14 has been smoothed with 50 smoothing iterations. This provides a more formable transition of wall angle(s) 88 from part surface 16 to addendum surface 27, while maintaining a geometry where the geometric representation 60 of sheet metal part 16 remains unchanged.

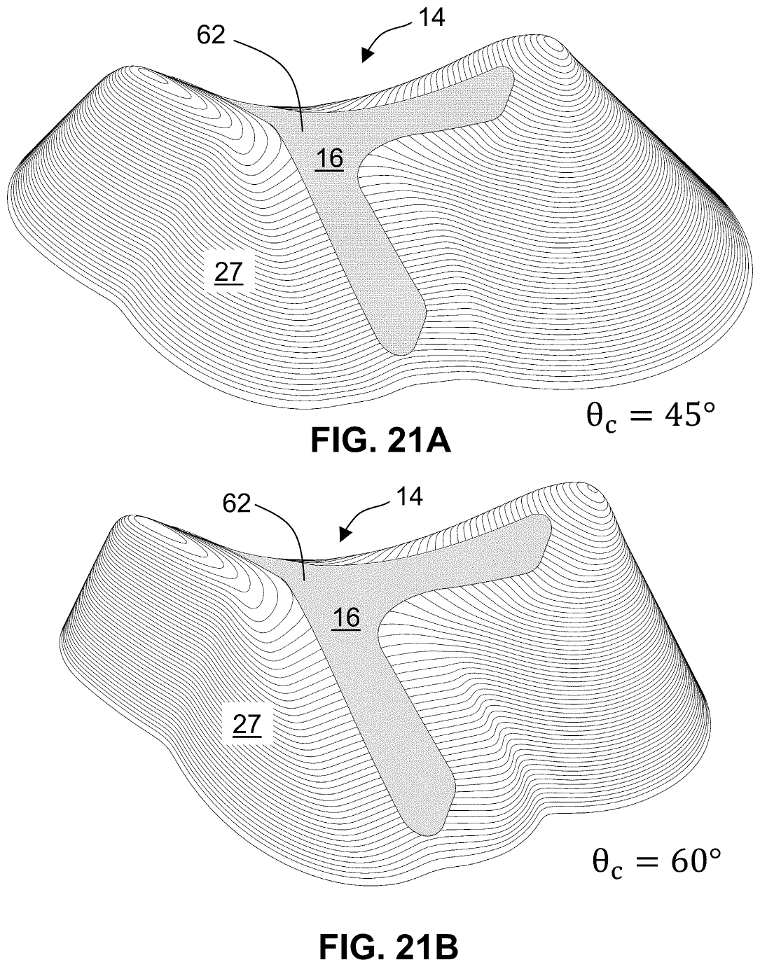

FIG. 21A shows a schematic perspective view of an example of a reference surface 14 generated for a branched sheet metal part 16 using the currently disclosed method. The reference surface 14 includes an addendum surface 27 with a user-specified constant design wall angle 88 where θ=45°. Reference surface 14 does not contain any regions of self-intersection, due to the presently disclosed method.

FIG. 21B shows a schematic perspective view of an example of a reference surface 14 generated for a branched sheet metal part 16 using the currently disclosed method, for which part surface 62 is coincident. The reference surface 14 includes an addendum surface 27 with a user-specified constant design wall angle 88, where θ_{c}=60°. Reference surface 14 does not contain any regions of self-intersection, due to the presently disclosed method.

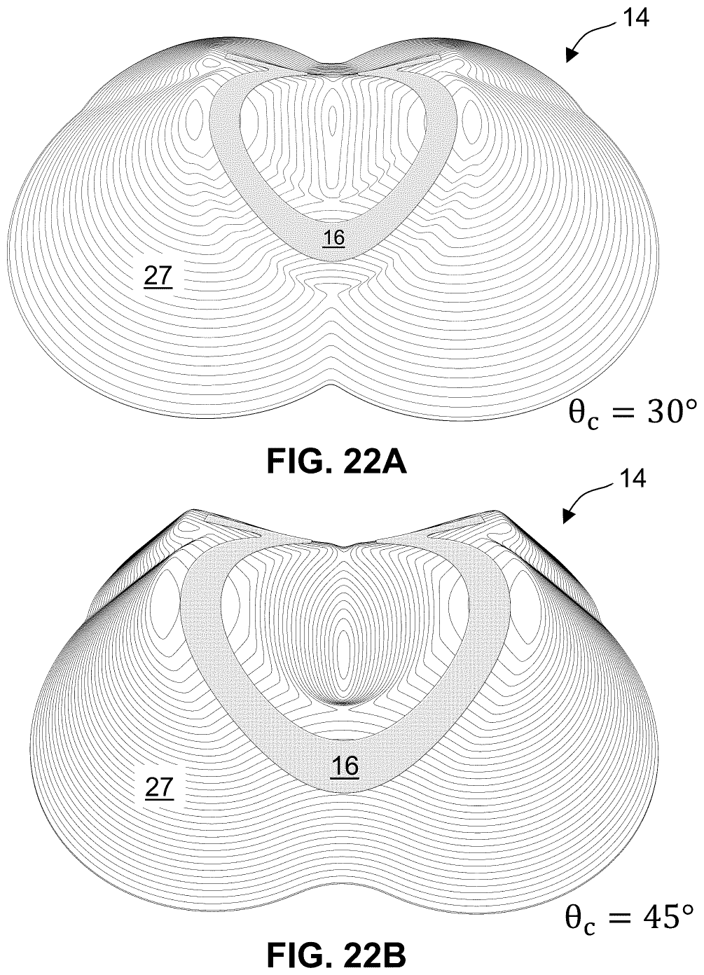

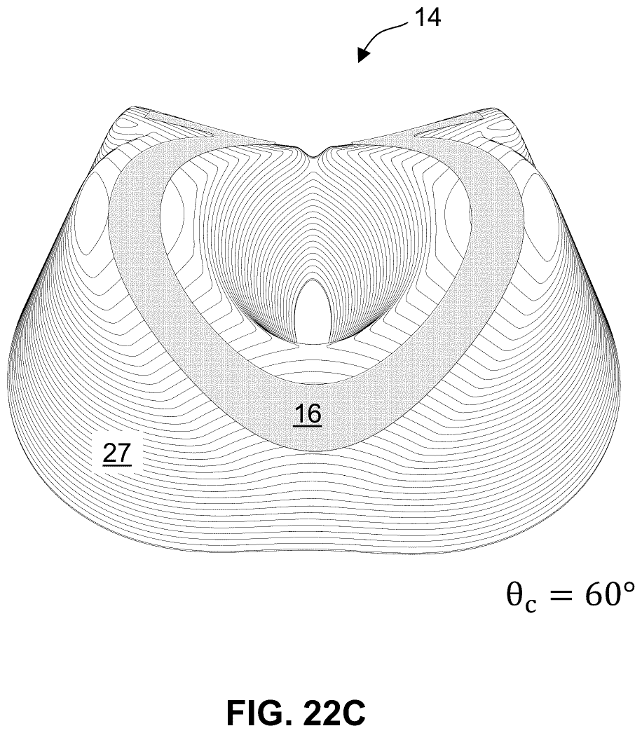

FIG. 22A shows a schematic perspective view of an example of a reference surface 14 generated for an omega-shaped sheet metal part 16 using the currently disclosed method, for which sheet metal part 16 is coincident. The reference surface 14 contains an addendum surface 27 with a user-specified constant design wall angle 88, where θ_{c}=30°. Reference surface 14 does not contain any regions of self-intersection, due to the presently disclosed method.

FIG. 22B shows a schematic perspective view of an example of a reference surface 14 generated for an omega-shaped sheet metal part 16 using the currently disclosed method, for which sheet metal part 16 is coincident. The reference surface 14 includes an addendum surface 27 with a user-specified constant design wall angle 88, where θ_{c}=45°. Reference surface 14 does not contain any regions of self-intersection, due to the presently disclosed method.

FIG. 22C shows a schematic perspective view of an example of a reference surface 14 generated for an omega-shaped sheet metal part 16 using the currently disclosed method, for which sheet metal part 16 is coincident. The reference surface 16 contains an addendum surface 27 with a wall angle 88, where θ_{c}=60°. Reference surface 14 does not contain any regions of self-intersection, due to the presently disclosed method.

FIG. 23 shows a schematic perspective view of an example of an ISF machine 58. ISF machine 58 comprises bed 54A (to which underform tool 7 is mounted), arm 54B containing the collet 57 and attached stylus tool 12, and overhead gantry 54C. Bed 54A has CNC controlled movement in the X-direction, while arm 54B allows CNC controlled movement of the stylus in the Z-direction, and overhead gantry 54C provides CNC controlled movement to arm 54B in the Y-direction. Collectively, these computer-controlled motions allow stylus tool 12 to closely traverse a stylus Z-level toolpath 50 during ISF operations. Sheet metal blank 10 (shown cut-away) is held down by clamp 8 (also shown cut-away).

A variety of methods for generating stylus toolpaths for ISF manufacturing have been developed by the present inventor and are disclosed in the following issued patents or published patent applications. All of the following patents and published patent applications are incorporated by reference herein in their entirety: U.S. Pat. Nos. 10,775,771; 11,579,583; 9,676,019; 11,586,173; US 2022/0410330; US 2023/0035585; US 2021/0373524; EP 4108357; EP 3742246; and EP 4151331.

What is claimed is:

1. A computer-implemented method of generating an addendum surface for use in forming a sheet metal part by using an Incremental Sheet Forming (ISF) manufacturing process, wherein the method comprises:
providing a Computer Aided Design (CAD) geometry of the sheet metal part to be formed; and
generating an addendum surface that surrounds and extends the CAD geometry;
wherein the addendum surface has a constant slope everywhere.

2. The computer-implemented method of claim 1, wherein the addendum surface has no regions of self-intersection.

3. The computer-implemented method of claim 1, further comprising:
extracting one or more part outer edge loops from the CAD geometry; and
generating one or more contiguous buffer zone surfaces around the one or more part outer edge loops;
wherein the one or more contiguous buffer zone surfaces have one or more buffer zone edge slopes that match corresponding part outer edge slopes at every position along the one or more part outer edge loops.

4. The computer-implemented method of claim 1, further comprising choosing a user-specified design wall angle, θ_{c}, that prevents tearing of the sheet metal part due to excessive wall thinning during the ISF manufacturing process.

5. The computer-implemented method of claim 1, further comprising:
providing a user-specified design wall angle, θ_{c};
wherein the addendum surface has a wall angle, θ_{c} that is constant everywhere on the addendum surface; and
wherein the wall angle, θ_{c} is equal to the user-specified design wall angle, θ_{c}.

6. The computer-implemented method of claim 4, wherein the user-specified design wall angle, θ_{c}, is less than or equal to about 60°.

7. The computer-implemented method of claim 3, further comprising:
providing a user-specified Z-trimming coordinate value; and
generating a trimmed flat base for the addendum surface by removing any portions of the addendum surface that lie below the user-specified Z-trimming coordinate value.

8. The computer-implemented method of claim 7, further comprising manufacturing one or more underform tools by:
computationally joining the sheet metal part surface, the one or more contiguous buffer zone surfaces and the addendum surface with the trimmed flat base in a contiguous fashion to define a trimmed reference surface;
generating one or more underform tool CAD geometries that define one or more underform tools, each of which has a surface geometry that is coincident with at least part of the trimmed reference surface; and
manufacturing one or more underform tools using the generated one or more underform tool CAD geometries.

9. The computer-implemented method of claim 3, further comprising:
computationally joining the sheet metal part surface, the buffer zone surface, and the addendum surface in a contiguous fashion to make a reference surface; and
smoothing the reference surface to remove any surface discontinuities by performing one or more iterations of a Laplace, Laplace-Beltrami, or Taubin mesh smoothing algorithm.

10. A computer-implemented method of forming a sheet metal part using an Incremental Sheet Forming (ISF) manufacturing process, wherein the method comprises:
providing a Computer-Aided Design (CAD) geometry of a sheet metal part to be formed;
generating an addendum surface that surrounds and extends the CAD geometry, wherein the addendum surface has a fixed slope everywhere;
manufacturing one or more underform tools, each of which has an underform tool surface geometry that is coincident with at least part of the addendum surface and/or the sheet metal part surfaces; and
incrementally sheet forming the sheet metal part over the one or more underform tools.

11. A computer-implemented method of generating an addendum surface for use in forming a sheet metal part using an Incremental Sheet Forming (ISF) manufacturing process, wherein the method comprises:
providing a Computer Aided Design (CAD) geometry of a sheet metal part to be formed;
providing a user-specified design wall angle, θ_{c};
calculating a set of x, y, and z-coordinate values for the addendum surface wherein the coordinates are defined such that all wall angles, θ of the addendum surface are equal to the user-specified design wall angle, θ_{c}; and
generating the addendum surface using the set of x, y, and calculated z-coordinate values.

12. A computer-implemented method of forming a sheet metal repair patch using an Incremental Sheet Forming (ISF) manufacturing process, wherein the method comprises:
providing a Computer-Aided Design (CAD) geometry of a sheet metal repair patch to be formed;
providing a user-specified design wall angle, θ_{c};
generating an addendum surface from the CAD geometry, wherein the addendum surface has a constant slope everywhere that is defined by the user-specified design wall angle, θ_{c};
manufacturing an underform tool that includes the addendum surface; and
incrementally sheet forming the sheet metal repair patch over the underform tool.

13. A computer-implemented method of generating a reference surface for use in a sheet forming manufacturing process, wherein the method comprises:
(a) receiving from a user a geometrical representation of a sheet metal part to be formed, wherein the sheet metal part has a part surface;
(b) receiving a user-specified design wall angle, θ_{c};
(c) extracting one or more part outer edge loops from the part surface;
(d) receiving a user-specified buffer zone width;
(e) constructing one or more buffer zone surfaces by extending the one or more part outer edge loops by a distance equal to the user-specified buffer zone width in a direction that is constrained to lie within a local tangent space of the part surface at all points along the one or more part outer edge loops;
(f) extracting one or more buffer zone outer edge loops from the buffer zone surface;
(g) generating one or more planar loops by projecting the one or more buffer zone outer edge loops onto an XY datum plane;
(h) computing a modified distance field, f;
(i) generating the reference surface comprising a plurality of reference points with x, y and calculated z coordinate values that satisfy a condition that f=0, and
(j) manufacturing the sheet metal part from a sheet blank by using the reference surface with the sheet forming manufacturing process.

14. The computer-implemented method of claim 13, wherein the modified distance field, f is defined according to Eq. (1), as follows:
$$f = {( x - \hat{x} )}^{2} + {( y - \hat{y} )}^{2} - {tan}^{2} ( {θ}_{c} ) {( z - \hat{z} )}^{2} \qquad Eq . ( 1 )$$
wherein, given a reference point with x, y, and calculated z reference coordinates, then \hat{x}, ŷ and \hat{z} equal the x, y, and z coordinates, respectively, of a closest point from the reference point along the one or more buffer zone outer edge loops;
wherein if the x and y coordinates of the reference point lie outside of the planar loop, then a corresponding z coordinate value equals a calculated z coordinate value that satisfies the condition that f=0;
wherein if one or more calculated z coordinates satisfy the condition that f=0, for the reference point with x and y coordinates, then the corresponding z coordinate equals a minimum z coordinate value selected from the one or more calculated z coordinates;
wherein if no z coordinate satisfies the condition that f=0, for the reference point with x and y coordinates, then the calculated z coordinate equals a z coordinate value that minimizes the modified distance field, f, and
wherein if the x and y coordinates are located inside of the planar loop, then calculate a point of intersection between a vertical line, having the same x and y coordinates as the reference point, and the part surface, wherein the calculated z coordinate is equal to a z-coordinate value of the point of intersection.

15. The computer-implemented method of claim 13, wherein constructing the one or more buffer zone surfaces comprises extending the one or more part outer edge loops in a direction that is locally perpendicular to the one or more planar loops.

16. The computer-implemented method of claim 13, further comprising
(a) calculating the modified distance field, f on a voxel grid; and
(b) using a marching-cubes or marching-tetrahedrons algorithm to generate a level set surface (18) of a level set;
wherein a value of the level set is set equal to zero; and
wherein if more than one calculated z coordinate points exist with a given combination of x and y coordinates, then a reference point having a minimum z coordinate value is used.

17. The computer-implemented method of claim 14 further comprising using a secant method to solve Eq. (1) for a z coordinate value, given x and y coordinate values of a reference point, which satisfies the condition that f=0.

18. The computer-implemented method of claim 15, wherein if there is no valid real-valued solution to the modified distance value, f being zero for the reference point with x and y coordinates and given a user-specified design wall angle, θ_{c}, then the method further comprises using an optimization algorithm to seek a z-coordinate that minimizes f.

19. The computer-implemented method of claim 18, wherein the optimization algorithm comprises a Nelder-Mead optimization algorithm.

20. The computer-implemented method of claim 13, further comprising smoothing the reference surface to remove one or more surface discontinuities by using one or more iterations of a Laplace, Laplace-Beltrami, or Taubin mesh smoothing algorithm.

21. The computer-implemented method of claim 13, further comprising:
receiving a user-specified Z-trimming coordinate value;
constructing a trimming plane at the user-specified Z-trimming coordinate value; and
trimming the reference surface to remove all portions of the reference surface that lie below the trimming plane.

22. A computer-implemented method of manufacturing a sheet metal part by using an Incremental Sheet Forming (ISF) machine, wherein the method comprises:
providing an ISF machine that has a stylus tool;
generating a reference surface of a sheet metal part, that has a part surface, wherein the reference surface includes a plurality of reference points;
smoothing one or more discontinuities in the reference surface;
trimming the reference surface with a trimming plane and removing all portions of the reference surface that lie below a user-specified Z-trimming coordinate value;
generating a stylus Z-level toolpath by using the smoothed and trimmed reference surface;
exporting the stylus Z-level toolpath in a Computer Numerically Controlled (CNC) format that is compatible with a controller that controls operation of the ISF machine; and
forming the sheet metal part from a sheet blank by programming and operating the incremental sheet forming machine to follow the stylus Z-level toolpath;
wherein the reference surface includes a union of the part surface, a contiguous buffer zone surface, and a contiguous addendum surface having a user-specified design wall angle, θ_{c}; and
wherein the plurality of reference points on the contiguous addendum surface include a subset of a level set surface (18) of a modified distance field, f; wherein f=0.

23. The computer-implemented manufacturing method of claim 22 wherein the modified distance field, f is defined according to Eq. (1), as follows:
$$f = {( x - \hat{x} )}^{2} + {( y - \hat{y} )}^{2} - {tan}^{2} ( {θ}_{c} ) {( z - \hat{z} )}^{2} \qquad Eq . ( 1 )$$
wherein, given a reference point with x, y, and calculated z reference coordinates, then \hat{x}, ŷ and \hat{z} equal the x, y, and z coordinates, respectively, of a closest point from the reference point along one or more buffer zone outer edge loops;
wherein if the x and y coordinates of a reference point lie outside of a planar loop, then a corresponding z coordinate value equals a calculated z coordinate value that satisfies a condition that f=0;
wherein if one or more calculated z coordinates satisfy the condition that f=0, for a reference point with x and y coordinates, then the corresponding z coordinate equals a minimum z coordinate value selected from the one or more calculated z coordinates;
wherein if no z coordinate satisfies the condition that f=0, for a reference point with x and y coordinates, then the calculated z coordinate equals a z coordinate value that minimizes the modified distance field, f; and
wherein if the x and y coordinates are located inside of the one or more planar loops, then calculate a point of intersection between a vertical line, having the same x and y coordinates as the reference point, and the part surface, wherein the calculated z coordinate is equal to a z-coordinate value of the point of intersection.

24. The computer-implemented method of claim 22, further comprising:
manufacturing one or more underform tools that comprise at least some portion of the reference surface;
supporting the sheet blank with the one or more underform tools; and
forming the sheet metal part from the sheet blank by programming and operating a Two-Point Incremental Forming (TPIF) machine that uses a stylus tool to follow the stylus Z-level toolpath.

25. The computer-implemented method of claim 22, further comprising manufacturing the sheet metal part from the sheet blank by programming and operating a Single Point Incremental Forming (SPIF) machine to elastoplastically deform the sheet blank, without using any physical support from an underform tool.

26. The computer-implemented method of claim 22, further comprising manufacturing the sheet metal part from the sheet blank by programming and operating a Dual Sided Incremental Forming (DSIF) machine with two opposing stylus tools that move together in a synchronous manner to elastoplastically deform a sheet blank that is positioned between the two opposing stylus tools, without using any physical support from an underform tool.

27. A non-transitory, computer-readable, digital storage medium comprising computer instructions for executing a computer program that implements a computerized method of generating a reference surface for use in a sheet forming manufacturing process, comprising computer instructions for:
(a) receiving from a user a geometrical representation of a sheet metal part to be formed, wherein the sheet metal part has a part surface;
(b) receiving a user-specified design wall angle, θ_{c};
(c) extracting one or more part outer edge loops from the part surface;
(d) receiving a user-specified buffer zone width;
(e) constructing one or more buffer zone surfaces by extending the one or more part outer edge loops by a distance equal to the user-specified buffer zone width in a direction that is constrained to lie within a local tangent space of the part surface at all points along the part outer edge loop;
(f) extracting one or more buffer zone outer edge loops from the one or more buffer zone surfaces;
(g) generating one or more planar loops by projecting the one or more buffer zone outer edge loops onto an XY datum plane;
(h) computing a modified distance field, f;
(i) generating the reference surface comprising a plurality of reference points with x, y and calculated z coordinate values that satisfy a condition that f=0, and
(j) manufacturing the sheet metal part from a sheet blank by using the reference surface with the sheet forming manufacturing process.

28. The non-transitory, computer-readable, digital storage medium of claim 27,
wherein the modified distance field, f is defined according to Eq. (1), as follows:
$$f = {( x - \hat{x} )}^{2} + {( y - \hat{y} )}^{2} - {tan}^{2} ( {θ}_{c} ) {( z - \hat{z} )}^{2} \qquad Eq . ( 1 )$$
wherein, given a reference point with x, y, and calculated z reference coordinates, then \hat{x}, ŷ and \hat{z} equal the x, y, and z coordinates, respectively, of a closest point from the reference point along the one or more buffer zone outer edge loops;
wherein if the x and y coordinates of the reference point lie outside of the one or more planar loops, then a corresponding z coordinate value equals a calculated z coordinate value that satisfies the condition that f=0;
wherein if one or more calculated z coordinates satisfy the condition that f=0, for the reference point with x and y coordinates, then the corresponding z coordinate equals a minimum z coordinate value selected from the one or more calculated z coordinates;
wherein if no z coordinate satisfies the condition that f=0, for the reference point with x and y coordinates, then the calculated z coordinate equals a z coordinate value that minimizes the modified distance field, f; and
wherein if the x and y coordinates are located inside of the planar loop, then calculate a point of intersection between a vertical line, having the same x and y coordinates as the reference point, and the part surface, wherein the calculated z coordinate is equal to a z-coordinate value of the point of intersection.

29. The non-transitory, computer-readable, digital storage medium of claim 27, further comprising computer instructions for:
(1) inputting a user-specified buffer zone width;
(2) inputting a user-specified design wall angle, θ_{c} for an addendum surface;
(3) inputting a user-specified Z-trimming coordinate value;
(4) removing a lower portion of the reference surface that lies below the user-specified Z-trimming plane;
(5) selecting a smoothing option, and inputting a weighting factor when smoothing is selected;
(6) generating a smoothed and trimmed reference surface by using the user-specified Z-trimming coordinate;
(7) generating a stylus Z-level toolpath based on the smoothed and trimmed reference surface; and
(8) exporting the stylus Z-level toolpath in a Computer Numerically Controlled (CNC) format that is compatible with a controller that controls operation of an Incremental Sheet Forming (ISF) machine.

30. The non-transitory, computer-readable, digital storage medium of claim 29, wherein the ISF machine comprises a Two-Point Incremental Forming (TPIF) machine.
